(19) United States
(12) Patent Application Publication
(10) Pub. No.: US 2026/0336453 A1
(43) Pub. Date: Oct. 29, 2026

(54) SINGLE STAGE ISOLATED BIDIRECTIONAL MULTI-PORT ON-BOARD CHARGER

(71) Applicants: AISIN CORPORATION, Kariya (JP); INDIAN INSTITUTE OF TECHNOLOGY KHARAGPUR, Kharagpur (IN)

(72) Inventors: Subrata SAHA, Kariya-shi (JP); Keisuke NAKAMURA, Kariya-shi (JP); Keisuke USHIDA, Kariya-shi (JP); Yutaka HOTTA, Kariya-shi (JP); Souvik CHATTOPADHYAY, Kalyani (IN)

(73) Assignees: AISIN CORPORATION, Kariya (JP); INDIAN INSTITUTE OF TECHNOLOGY KHARAGPUR, Kharagpur (IN)

(21) Appl. No.: 19/651,011

(22) Filed: Apr. 17, 2026

(30) Foreign Application Priority Data
Apr. 24, 2025 (IN) 202511039653

(51) Int. Cl. B60L 53/62; H02J 3/32; H02M 1/00; H02M 1/12; H02M 1/14; H02M 3/335

(52) U.S. Cl. CPC B60L 53/62; H02J 3/322; H02M 1/0043; H02M 1/12; H02M 1/14; H02M 3/33561; H02M 3/33573; H02M 3/33584; B60L 2210/10

(57) ABSTRACT

A single stage isolated bidirectional multi-port On-Board Charger (OBC) includes a controller and dual active bridge converter including first full-bridge converter, active power decoupling circuit and one or more second full-bridge converters. To control input grid current harmonic distortion and second harmonic battery ripple current in OBC, the controller is configured to: select flat-top modulation strategy for first full bridge converter and one or more second full-bridge converters, select sinusoidal pulse width modulation for first full bridge converter, and select sinusoidal phase shift modulation for one or more second full-bridge converters.

### TECHNICAL FIELD

The present disclosure generally relates to the field of On-Board Chargers (OBCs) and more particularly relates to providing a single stage isolated bidirectional multi-port OBC with reduced second harmonic battery ripple current.

### BACKGROUND

On-board Chargers (OBCs) are generally equipped in Plug-in Hybrid Electric Vehicles (PHEVs) and Electric Vehicles (EVs), cumulatively referred to as Plug-in Electric Vehicles (PEVs). Conventionally, an OBC converts an alternating current (ac) voltage from a source terminal, such as a power grid, an ac-source, etc., to a direct current (dc) voltage. The dc voltage is then used to charge one or more battery loads associated with the PEVs.

The conversion of ac voltage to de voltage can either be done in two stages or in a single stage. A two-stage OBC comprises an AC-DC converter followed by a DC-DC converter. The AC-DC converter converts an input ac-voltage to corresponding dc-voltage while the DC-DC converter regulates the dc-voltage. The two-stage OBC further comprises a large DC-link capacitor which acts as a decoupling capacitor and is also utilized to reduce second harmonic battery ripple current to a certain extent. In addition to the AC-DC converter, and the DC-DC converter the two-stage OBC comprises power devices which increases both the cost and the volume of the OBC. Further, efficiency of the two-stage OBC is also reduced because of the two-stage power conversion.

While the single stage OBC overcomes the limitations of bulkiness, high costs and low-efficiency as encountered in two-stage OBC, one of the major limitations of the single stage OBC is the presence of second harmonic battery ripple current which is detrimental to the life of a battery load being charged by the OBC.

The information disclosed in this background of the disclosure section is only for enhancement of understanding of the general background of the disclosure and should not be taken as an acknowledgement or any form of suggestion that this information forms the prior art already known to a person skilled in the art.

### SUMMARY

The foregoing summary is illustrative only and is not intended to be in any way limiting. In addition to the illustrative aspects, embodiments, and features described above, further aspects, embodiments, and features will become apparent by reference to the drawings and the following detailed description.

In a non-limiting embodiment of the present disclosure, a single stage isolated bidirectional multi-port On-Board Charger (OBC). The OBC comprises a dual active bridge converter. The dual-active bridge converter comprises a first full-bridge converter connected to a primary winding of a transformer. In an exemplary aspect, the first full-bridge converter comprises a first switching circuit and a second switching circuit. The dual-active bridge converter further comprises an active power decoupling circuit in electrical communication with a source terminal and the first full-bridge converter. In an exemplary aspect, the active power decoupling circuit comprises a third switching circuit and one or more passive devices. The dual-active bridge converter further comprises one or more second full-bridge converters connected to one or more secondary windings of the transformer. In an exemplary aspect, each of the one or more second full-bridge converters are connected to a load. In another exemplary aspect, each of the one or more second full-bridge converters comprises one or more second switching circuits. The OBC further comprises a controller in electrical communication with the dual-active bridge converter and configured to control an input grid current harmonic distortion and a second harmonic battery ripple current generated in the dual active bridge converter within a predefined range during one or more operating modes of the OBC.

In another non-limiting embodiment of the present disclosure, to control the input grid current harmonic distortion, the controller is configured to select a turn ratio of the transformer such that an amplitude of voltage across the primary winding is equal to an amplitude of voltage across the one or more secondary windings.

In yet another non-limiting embodiment of the present disclosure, to control the input grid current harmonic distortion and the second harmonic battery ripple current in the single stage isolated bidirectional multi-port OBC, the controller is configured to select a flat-top modulation strategy for the first full bridge converter and the one or more second full-bridge converters. The controller is further configured to select sinusoidal pulse width modulation for the first full bridge converter. The controller is further configured to select sinusoidal phase shift modulation for the one or more second full-bridge converters. Further, the controller is configured to select, a reference carrier based on one or more operating modes of the OBC. The controller is further configured to determine, during each switching period, a phase shift of a carrier associated with at least one switching circuit of a plurality of switching circuits of the dual-active bridge converter, with respect to the selected reference carrier, such that a voltage across the one or more secondary windings has an identical pulse width and is phase modulated with respect to a voltage across the primary winding to transmit constant power through the dual-active bridge converter. Furthermore, the controller is configured to determine a modulating signal based on the determined phase shift of the carrier.

In yet another non-limiting embodiment of the present disclosure, the OBC is configured in one of: a two-port configuration and a three-port configuration.

In yet another non-limiting embodiment of the present disclosure, in the two-port configuration, a dual active bridge converter comprises a second full-bridge converter connected to a High-Voltage battery (HVB) load.

In yet another non-limiting embodiment of the present disclosure, in the three-port configuration, a dual-active bridge converter comprises two second full-bridge converters. In an exemplary aspect, one of the second full-bridge converters is connected to a High-Voltage Battery (HVB) load, and another second full-bridge converter is connected to a Low-Voltage Battery (LVB) load.

In yet another non-limiting embodiment of the present disclosure, the one or more operating modes comprises a Grid-to-Vehicle (G2V) mode and a Vehicle-to-Grid (V2G) mode at a rest condition of a vehicle and a Vehicle (V) mode during a driving condition of the vehicle.

In yet another non-limiting embodiment of the present disclosure, for a first switching circuit and a second switching circuit of a first full-bridge converter and a third switching circuit of an active power decoupling circuit associated with the dual-active bridge converter, to control the second harmonic battery ripple current in one of: a two-port and a three-port configuration during a Grid-to-Vehicle (G2V) operating mode, the controller is configured to select a carrier associated with the first switching circuit as a reference carrier. The controller is further configured to phase delay a carrier associated with the second switching circuit and the third switching circuit with respect to the reference carrier by a first predefined angle. In an exemplary aspect, the first predefined angle is equal to a half switching period. The controller is further configured to determine a modulating signal for the carrier associated with the first and the second switching circuits and for the carrier associated with the third switching circuit, based on a base modulating signal, such that the modulating signal for the carrier associated with the first and the second switching circuits is 180° opposite to the modulating signal for the carrier associated with the third switching circuit.

In yet another non-limiting embodiment of the present disclosure, for a second full-bridge converter of the dual-active bridge converter connected to a High-Voltage Battery (HVB) load, to control the second harmonic battery ripple current in one of: the two-port and the three-port configuration during the Grid-to-Vehicle (G2V) operating mode, the controller is further configured to phase delay a carrier associated with a fourth switching circuit of the second full-bridge converter connected to the HVB load with respect to the reference carrier by a second predefined angle. The controller is further configured to phase delay a carrier associated with a fifth switching circuit of the second full-bridge converter connected to the HVB load with respect to the carrier associated with the second switching circuit by a third predefined angle. In an exemplary aspect, the second predefined angle comprises a summation of a first and a second variable phase shift component and the third predefined angle comprises a subtraction of the first and the second variable phase shift components, that contributes for a constant power transmission from the first full-bridge converter to the second full-bridge converter connected to the HVB load. Further, the controller is configured to determine a modulating signal for the carrier associated with the fourth and the fifth switching circuits. In an exemplary aspect, the modulating signal for the carrier associated with fourth switching circuit and the modulating signal for the carrier associated with the fifth switching circuit has a same value equal to half of a duty period of the second full-bridge converter of the dual-active bridge converter connected to the HVB load. In an exemplary aspect, a voltage across a first winding of the secondary winding lags a voltage across the primary winding by an angle equal to the variable phase shift component. In another exemplary aspect, the variable phase shift component varies at a frequency which is twice a frequency associated with the source terminal.

In yet another non-limiting embodiment of the present disclosure, for a second full-bridge converter of the dual-active bridge converter connected to a Low-Voltage Battery (LVB) load, to control the second harmonic battery ripple current in the three-port configuration during the Grid-to-Vehicle (G2V) operating mode, the controller is further configured to phase delay a carrier associated with a sixth switching circuit of the second full-bridge converter connected to the LVB load with respect to the carrier associated with the fourth switching circuit by a fourth predefined angle. The controller is further configured to phase delay a carrier associated with a seventh switching circuit of the second full-bridge converter connected to the LVB load with respect to the carrier associated with the fifth switching circuit by the fourth predefined angle. The controller is further configured to determine a modulating signal for the carrier associated with the sixth and the seventh switching circuits. In an exemplary aspect, the modulating signal for the carrier associated with sixth switching circuit and the modulating signal for the carrier associated with the seventh switching circuit has a same value equal to half of a duty period of the second full-bridge converter of the dual-active bridge converter connected to the LVB load. In another exemplary aspect, a voltage across a second winding of the secondary winding lags a voltage across the first winding of the secondary winding by an angle equal to the fourth predefined angle. In yet another exemplary aspect, the fourth predefined angle varies at a frequency which is twice a frequency associated with the source terminal.

In yet another non-limiting embodiment of the present disclosure, for a second full-bridge converter of the dual-active bridge converter connected to a High-Voltage Battery (HVB) load, to control the second harmonic battery ripple current in one of: a two-port and a three-port configuration during a Vehicle-to-Grid (V2G) operating mode, the controller is configured to select a reference carrier, wherein the selected reference carrier has a time period equal to a half switching period. The controller is further configured to phase advance a carrier associated with a fourth switching circuit of the second full-bridge converter connected to the HVB load with respect to the selected reference carrier by a fifth predefined angle. The controller is further configured to phase advance a carrier associated with a fifth switching circuit of the second full-bridge converter connected to the HVB load with respect to the selected reference carrier by a sixth predefined angle. The controller is further configured to determine a modulating signal for the carrier associated with the fourth and the fifth switching circuits. In an exemplary aspect, the modulating signal for the carrier associated with fourth switching circuit and the modulating signal for the carrier associated with the fifth switching circuit has a same value equal to half of a duty period of the second full-bridge converter of the dual-active bridge converter connected to the HVB load.

In yet another non-limiting embodiment of the present disclosure, for a first switching circuit and a second switching circuit of a first full-bridge converter and a third switching circuit of an active power decoupling circuit associated with the dual-active bridge converter, to control the second harmonic battery ripple current in one of: the two-port and the three port configuration, during the V2G operating mode, the controller is further configured to phase delay a carrier associated with a first switching circuit with respect to the selected reference carrier by a seventh predefined angle, wherein the seventh predefined angle is determined based on a discharge power of the HVB load. The controller is further configured to phase delay a carrier associated with a second switching circuit and a carrier associated with the third switching circuit with respect to the selected reference carrier by an eighth predefined angle. In an exemplary aspect, the eighth predefined angle is based on the half-switching period and the seventh predefined angle. The controller is further configured to determine a modulating signal for the carrier associated with the first and the second switching circuits and for the carrier associated with the third switching circuit, based on a base modulating signal, such that the modulating signal for the carrier associated with the first and the second switching circuit is 180° opposite to the modulating signal for the carrier associated with the third switching circuit. In an exemplary aspect, a voltage across the primary winding lags a voltage across the first winding of the secondary winding by an angle equal to the seventh predefined angle. In another exemplary aspect, the seventh predefined angle varies at a frequency which is twice a frequency associated with the source terminal.

In yet another non-limiting embodiment of the present disclosure, for a second full-bridge converter of the dual-active bridge converter connected to a Low-Voltage Battery (LVB) load, to control the second harmonic battery ripple current in a three-port configuration, during the V2G operating mode, the controller is further configured to phase delay a carrier associated with a sixth switching circuit of the second full-bridge converter connected to the LVB load with respect to the carrier associated with the fourth switching circuit by a nineth predefined angle. The controller is further configured to phase delay a carrier associated with the seventh switching circuit of the second full-bridge converter connected to the LVB load with respect to the carrier associated with the fifth switching circuit by the nineth predefined angle. The controller is further configured to determine a modulating signal for the carrier associated with the sixth and the seventh switching circuits. In an exemplary aspect, the modulating signal for the carrier associated with sixth switching circuit and the modulating signal for the carrier associated with the seventh switching circuit has a same value equal to half of a duty period of the second full-bridge converter of the dual-active bridge converter connected to the LVB load. In another exemplary aspect, a voltage across a second winding of the secondary winding lags a voltage across the first winding of the secondary winding by an angle equal to the nineth predefined angle. In yet another exemplary aspect, the nineth predefined angle varies at a frequency which is twice a frequency associated with the source terminal.

In yet another non-limiting embodiment of the present disclosure, in a Grid-to-Vehicle (G2V) mode and in a Vehicle-to-Grid (V2G) operating mode, a carrier frequency of the first full-bridge converter is constant and is equal to an operating switching frequency of the OBC and carrier frequencies associated with the one or more second full-bridge converters are variable.

In yet another non-limiting embodiment of the present disclosure, the first variable phase shift component in G2V mode and the seventh predefined angle in the V2G mode are generated in one of: an online mode and an offline mode. In an exemplary aspect, in the offline mode, the variable phase shift component and the seventh predefined angle is selected from one or more look up tables. In another exemplary aspect, each of the one or more look up tables comprise a plurality of angle values for an electrical cycle of a frequency associated with a source terminal at a corresponding plurality of values associated with a modulation index of the first full-bridge converter.

In yet another embodiment of the present disclosure, in the three-port configuration, during the G2V and the V2G operating mode, the controller is configured to control a plurality of variables for a plurality of combinations of loads and output voltages associated with the HVB load and the LVB load in a manner that during an electrical cycle of a frequency associated with the source terminal, the input grid current harmonic distortion and the second harmonic battery ripple current generated in the HVB load are maintained within the pre-defined range.

In yet another embodiment of the present disclosure, the plurality of control variables comprises voltage pulse duty associated with the primary winding, voltage pulse duty associated with a first winding of the one or more secondary windings, voltage pulse duty associated with a second winding of the one or more secondary windings, a phase delay angle across the first winding of the one or more secondary windings with respect to the primary winding and a phase delay angle of the second winding of the one or more secondary windings with respect to the first winding of the one or more secondary windings.

In yet another embodiment of the present disclosure, in in the two-port configuration, during the G2V and the V2G operating mode, the controller is configured to control a plurality of control variables for a plurality of combinations of loads and output voltage associated with the HVB load in a manner that during an electrical cycle of a frequency associated with the source terminal, the input grid current harmonic distortion and the second harmonic battery ripple current generated in the HVB load are maintained within the pre-defined range.

In yet another embodiment of the present disclosure, the plurality of control variables comprises voltage pulse duty associated with the primary winding, voltage pulse duty associated with a secondary winding and a phase delay angle across the secondary winding with respect to the primary winding.

In yet another non-limiting embodiment of the present disclosure, for a second full-bridge converter of the dual-active bridge converter connected to a High-Voltage Battery (HVB) load a three-port configuration, to charge the Low-Voltage Battery (LVB) from the High-Voltage Battery (HVB) during a driving condition of a vehicle, the controller is configured to select a carrier associated with a fourth switching circuit of the second full-bridge converter connected to the HVB load as a reference carrier. In an exemplary aspect, a frequency of the carrier associated with the fourth switching circuit is equal to an operating frequency of the dual-active bridge converter. The controller is further configured to phase advance a carrier associated with the fifth switching circuit of the second full-bridge converter connected to the HVB load with respect to the selected reference carrier by a time period equal to a duty cycle of the second full-bridge converter. Further, the controller is configured to determine a modulating signal for the carrier associated with the fourth and the fifth switching circuits. In an exemplary aspect, the modulating signal for the carrier associated with fourth switching circuit and the modulating signal for the carrier associated with the fifth switching circuit has a same value equal to half of a duty period of the second full-bridge converter of the dual-active bridge converter connected to the HVB load.

In yet another non-limiting embodiment of the present disclosure, for a second full-bridge converter of the dual-active bridge converter connected to a Low-Voltage Battery (LVB) load in a three-port configuration, to charge the Low-Voltage Battery (LVB) from the High-Voltage Battery (HVB) during a driving condition of a vehicle, the controller is configured to phase delay a carrier associated with the sixth switching circuit of the second full-bridge converter connected to the LVB load with respect to the selected reference carrier by a tenth predefined angle. The controller is further configured to phase delay a carrier associated with the seventh switching circuit of the second full-bridge converter connected to the LVB load with respect to the carrier associated with the fifth switching circuit by the tenth predefined angle. The controller is further configured to determine a modulating signal for the carrier associated with the sixth and the seventh switching circuits. In an exemplary aspect, the modulating signal for the carrier associated with sixth switching circuit and the modulating signal for the carrier associated with the seventh switching circuit has a same value equal to half of a duty period of the second full-bridge converter of the dual-active bridge converter connected to the LVB load. In another exemplary aspect, a voltage across a second winding of the secondary winding lags a voltage across a first winding of the secondary winding by an angle equal to the tenth predefined angle.

### BRIEF DESCRIPTION OF THE DRAWINGS

The accompanying drawings, which are incorporated in and constitute a part of this disclosure, illustrate exemplary embodiments and, together with the description, serve to explain the disclosed principles. The same numbers are used throughout the figures to reference like features and components. Some embodiments of at least one of device and methods in accordance with embodiments of the present subject matter are now described, by way of example only, and with reference to the accompanying figures, in which:

FIG. 1 depicts a block diagram 100 of a single stage isolated bidirectional multi-port On-Board Charger (OBC) in accordance with an embodiment of the present disclosure,

FIG. 2A depicts a circuit diagram 200A of a single stage isolated bidirectional two-port On-Board Charger (OBC), in accordance with an embodiment of the present disclosure,

FIG. 2B depicts a circuit diagram 200B of a single stage isolated bidirectional three-port On-Board Charger (OBC), in accordance with an embodiment of the present disclosure,

FIG. 2C depicts exemplary waveforms 200C illustrating flattop modulation strategy, in accordance with an embodiment of the present disclosure,

FIG. 3A depicts power flow within a circuit 300A of a single stage isolated two-port On-Board Charger (OBC) during a Grid-to-Vehicle (G2V) operating mode, in accordance with an embodiment of the present disclosure,

FIG. 3B depicts power flow within a circuit 300B of a single stage isolated three-port On-Board Charger (OBC) during a Grid-to-Vehicle (G2V) operating mode, in accordance with an embodiment of the present disclosure,

FIG. 4 depicts, by way of a flow diagram 400, carrier modulation for a single stage isolated bidirectional two port or three-port On-Board Charger (OBC), during a Grid-to-Vehicle (G2V) operating mode, in accordance with an embodiment of the present disclosure,

FIG. 5 depicts a circuit diagram 500 for generation of a base modulation signal, in accordance with an embodiment of the present disclosure,

FIG. 6 depicts a circuit diagram 600 for generation of a variable phase shift component (φ_{mod}), in accordance with an embodiment of the present disclosure,

FIG. 7 depicts a circuit diagram 700 for generation of a phase delay angle (φ₂), in accordance with an embodiment of the present disclosure,

FIGS. 8A-8E depict waveforms 800A-800E respectively corresponding to carriers, modulation signals and voltages across an ac-side and an dc-side of a dual-active bridge converters, grid current and High-Voltage Battery (HVB) and Low-Voltage Battery (LVB) currents in a Grid-to-Vehicle (G2V) operating mode, in accordance with an embodiment of the present disclosure,

FIG. 9A depicts power flow within a circuit 900A of a single stage isolated two-port On-Board Charger (OBC) during a Vehicle-to-Grid (V2G) operating mode, in accordance with an embodiment of the present disclosure,

FIG. 9B depicts power flow within a circuit 900B of a single stage isolated three-port On-Board Charger (OBC) during a Vehicle-to-Grid (V2G) operating mode, in accordance with an embodiment of the present disclosure,

FIG. 10 depicts, by way of a flow diagram 1000, carrier modulation for a single stage isolated bidirectional two port or three-port On-Board Charger (OBC), during a Vehicle-to-Grid (V2G) operating mode, in accordance with an embodiment of the present disclosure,

FIGS. 11A-11E depict waveforms 1100A-1100E respectively corresponding to carriers, modulation signals and voltages across an ac-side and an dc-side of a dual-active bridge converters, grid current and High-Voltage Battery (HVB) and Low-Voltage Battery (LVB) currents in a Vehicle-to-Grid (V2G) operating mode, in accordance with an embodiment of the present disclosure,

FIG. 12 depicts power flow within a circuit 1200 of a single stage isolated three-port On-Board Charger (OBC) during a driving condition of a vehicle, in accordance with an embodiment of the present disclosure,

FIG. 13 depicts, by way of a flow diagram 1300, carrier modulation for a single stage isolated bidirectional three-port On-Board Charger (OBC), during a driving condition of a vehicle, in accordance with an embodiment of the present disclosure,

FIG. 14 depicts a circuit diagram 1400 for generation of a duty period, in accordance with an embodiment of the present disclosure, and

FIGS. 15A-15E depict waveforms 1500A-1500E respectively corresponding to carriers, modulation signals and voltages across an ac-side and an dc-side of a dual-active bridge converters, High-Voltage Battery (HVB) and Low-Voltage Battery (LVB) currents during a driving condition of a vehicle, in accordance with an embodiment of the present disclosure.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

As described in the background section that while single stage On-Board Chargers (OBCs) are efficient when it comes to power conversion efficiency, size and cost, however, one of the major issues faced by the single stage OBCs is the presence of high second harmonic battery ripple current which is detrimental to the life of a battery load being charged by the OBC.

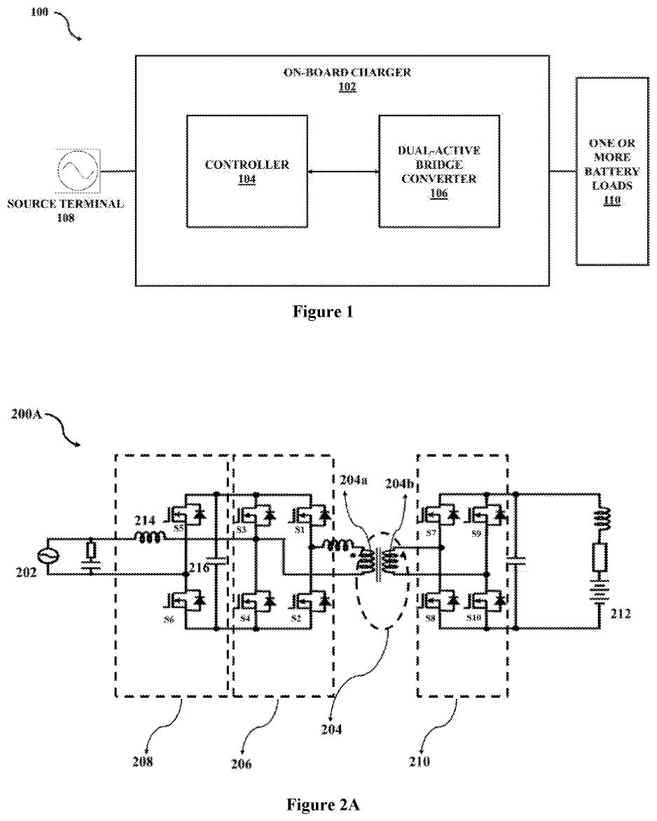

In order to control the second harmonic battery ripple current and to also reduce distortion in input grid current within a pre-defined (permissible) range, the present disclosure describes a design configuration and a control strategy for a single stage isolated bidirectional multi-port OBC. In an exemplary embodiment, for a typical grid frequency of 50 Hz, a pre-defined second harmonic battery current ripple consists of 100 Hz. A detailed description of the proposed control strategy OBC is provided in the upcoming paragraphs in conjunction with FIGS. 1-15.

FIG. 1 depicts a block diagram 100 of a single stage isolated bidirectional multi-port OBC (herein after referred to as OBC), in accordance with an embodiment of the present disclosure. In particular, the block diagram 100 depicts an OBC 102 comprising a controller 104 and a dual-active bridge converter 106. The OBC 102 is connected to a source terminal 108. In an embodiment, the source terminal 108 is an ac-voltage source configured to provide ac-voltage to the OBC 102, for instance a grid. The OBC 102 is further connected to one or more battery loads 110 that needs to be charged by the OBC 102. In an embodiment, the one or more battery loads 110 may be associated with a vehicle. Further, in an embodiment, the one or more battery loads 110 that can be connected to the OBC 102 may vary based on the number of ports of the OBC 102.

In an exemplary embodiment, the OBC 102 may be configured in a two-port or a three-port configuration. In the two-port configuration, the OBC 102 may comprise an input port connected to the source terminal 108 and an output port connected to a battery load. In an exemplary aspect, the output port is connected to a High-Voltage Battery (HVB) load. Further, in the three-port configuration, the OBC 102 may comprise an input port connected to the source terminal 108 and two output ports connected to respective battery loads. In an exemplary aspect, one of the output ports may be connected to a High-Voltage Battery (HVB) load and the other output port may be connected to a Low-Voltage Battery (LVB) load.

In another exemplary embodiment, the bidirectional nature of the OBC 102 may be implemented based on one or more modes of operation of the OBC 102. In an exemplary aspect, the one or more modes of operation of the OBC 102 may comprise a Grid-to-Vehicle (G2V) mode and a Vehicle-to-Grid (V2G) during a rest condition of a vehicle. In the G2V mode, power may flow from a grid, such as the source terminal 108 to the one or more battery loads 110. On the other hand, in the V2G mode, power may flow from the one or more battery loads 110 to the source terminal 108. In yet another exemplary embodiment, the driving condition of the vehicle may correspond to a Vehicle (V) mode during which the Low-Voltage Battery (LVB) is charged from the High-Voltage Battery (HVB).

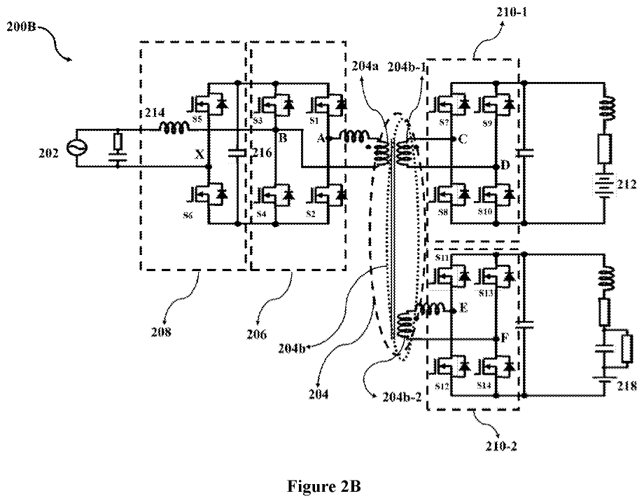

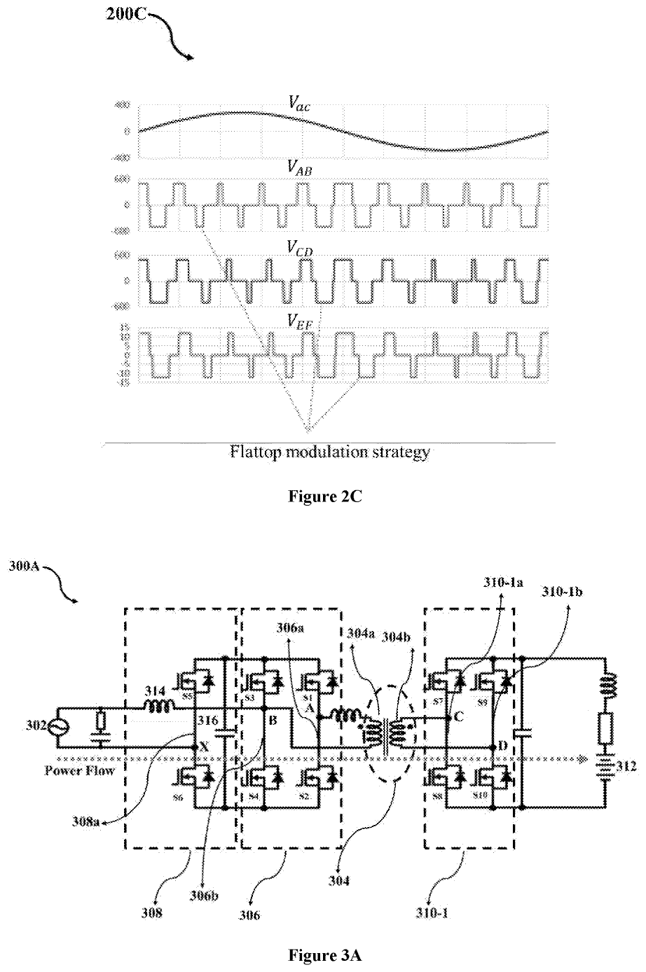

In yet another exemplary embodiment, a control strategy for controlling second harmonic battery ripple current generated in the dual-active bridge converter 106 may be implemented by the controller 104 which is in electrical communication with the dual-active bridge converter 106. In one embodiment, the controller 104 may be embodied as a multi-core processor, a single core processor, or a combination of one or more multi-core processors and one or more single core processors. For example, the controller 104 may be embodied as one or more of various processing devices, such as a coprocessor, a microprocessor, a controller, a Digital Signal Processor (DSP), a processing circuitry with or without an accompanying DSP, or various other processing devices including, a microcontroller unit (MCU), a hardware accelerator, a special-purpose computer chip, or the like. A detailed description of the design configuration of the OBC 102 in a two-port and a three-port configuration is provided in the upcoming paragraphs in conjunction with FIGS. 2A and 2B respectively.

FIGS. 2A and 2B depict circuit diagrams 200A and 200B of the OBC 102 in a two-port and a three-port configuration respectively, in accordance with an embodiment of the present disclosure. Referring to FIG. 2A, the circuit diagram 200A depicts a dual-active bridge converter comprising a first full-bridge converter 206, an active power decoupling circuit 208 and a second full-bridge converter 210. In an embodiment, the first full-bridge converter 206 and the second full-bridge converter 210 are connected respectively to a primary winding 204a and a secondary winding 204b of a transformer 204. In particular, the transformer 204 provides electric isolation between the components on its either side. The first full bridge converter 206 comprises a first switching circuit comprising switches S1 and S2, and a second switching circuit comprising switches S3 and S4. On similar lines, the second full bridge converter 210 comprises a fourth switching circuit comprising switches S7 and S8, and a fifth switching circuit comprising switches S9 and S10. Further, the second full bridge converter 210 is connected to a HVB load 212. Furthermore, the active power decoupling circuit 208 comprises a third switching circuit comprising switches S5 and S6 along with one or more passive devices. In an embodiment, the one or more passive devices include an inductor 214 and a capacitor 216. The third switching circuit is electrically connected to a source terminal 202 (analogous to the source terminal 108).

Referring to FIG. 2B, the circuit diagram 200B for the three-port configuration of the OBC 102 is similar to the circuit diagram 200A for the two-port configuration with a difference in a number of second full bridge converters. In the three-port configuration, as depicted in the circuit diagram 200B, two second full bridge converters denoted by reference numerals 210-1 and 210-2 are connected respectively to a first winding 204b-1 and a second winding 204b-2 of the secondary winding 204b. The second full bridge converter 210-1 is connected to the HVB load 212 and the second full bridge converter 210-2 comprising a sixth switching circuit and a seventh switching circuit is connected to LVB load 218. The sixth switching circuit comprises switches S11 and S12 and the seventh switching circuit comprises switches S13 and S14. In an embodiment, in the three-port configuration, a turn ratio of the transformer 204 is given as −1: 1/n₂: 1/n₃, where n₂ are n₃ are the number of turns of the windings 204b-1 and 204b-2 respectively.

It may be appreciated by a skilled person that the switches present in the dual-active bridge converter 106 may be implemented in the form of diodes, thyristors and transistors including but not limited to IGBTs (Insulated Gate Bipolar Transistors) and MOSFETs (Metal-Oxide-Semiconductor Field-Effect Transistors). It may further be appreciated by a skilled person that the switches present in the dual-active bridge converter 106 may be implemented by using wide-band gap semiconductor devices but not limited to Silicon Carbide and Gallium Nitride only.

Now, as described in reference to FIG. 1, the controller 104 implements a control strategy for controlling an input grid current distortion and a second harmonic battery ripple current generated in the dual-active bridge converter 106. In an embodiment, the control strategy is a flattop modulation strategy as illustrated in FIG. 2C. In an embodiment, as depicted in FIG. 2C, in the flat top modulation strategy, a voltage V_{AB} pulse duty associated with the primary winding 204a, a voltage V_{CD} pulse duty associated with the first winding 204b-1 of the secondary winding 204b and a voltage V_{EF} pulse duty associated with a second winding 204b-2 of the secondary winding 204b have maximum value at near the zero-crossings of the grid voltage V_{ac} and have minimum value near the peak value of the grid voltage V_{ac}. One of the objectives of the flattop modulation strategy is to control a distortion in input grid current, otherwise known as a current associated with the source terminal 108. To control the input grid current distortion, the controller 104 is configured to select a turn ratio of the transformer 204 such that an amplitude of voltage across the primary winding 204a is equal to an amplitude of voltage across the one or more secondary windings 204b. Further, another objective of the proposed flattop modulation strategy is to push constant power without any second harmonic power ripple through the dual-active bridge converter 106 during each switching cycle. To achieve this objective, an active power transmitted through the dual-active bridge converter 106 per switching cycle is regulated by the controller 104 by adjusting a phase shift of a carrier (with respect to a reference carrier) associated with at least one of a plurality of switching circuits. In an embodiment, the plurality of switching circuits comprises the first, the second, the third, the fourth, the fifth, the sixth and the seventh switching circuits. Further, to achieve the above-mentioned objective, the controller 104 adjusts the phase shift of the carrier in such a manner that a voltage across the secondary winding 204b has an identical pulse width and is phase modulated with respect to a voltage across the primary winding 204a. In particular, the controller 104 is configured to perform sinusoidal pulse width modulation at an ac-side of the dual-active bridge converter, i.e., the first full-bridge converter 206 and the third switching circuit associated with the active power decoupling circuit 208 in order to exercise direct control over the input ac current from the source terminal 202. Furthermore, the controller 104 is configured to perform sinusoidal phase shift modulation at a dc-side of the dual-active bridge converter, i.e., the second full bridge converter 210-1 connected to the HVB load 212 and the second full bridge converter 210-2 connected to LVB load 218

Upon determining the phase shift of the carrier, the controller 104 may then determine the modulating signal for the carrier based on the determined phase shift.

In an embodiment, the controller 104 may implement the control strategy based on the one or more modes of operation of the OBC and/or a state of a vehicle. For instance, the control strategy may be implemented for—
G2V mode of operation
V2G mode of operation
Driving condition of the vehicle i.e., the Vehicle (V) mode

It may, however, be appreciated by a skilled person that during the G2V mode and V2G mode, the vehicle may be at rest and hence, the same is not explicitly mentioned for the sake of brevity.

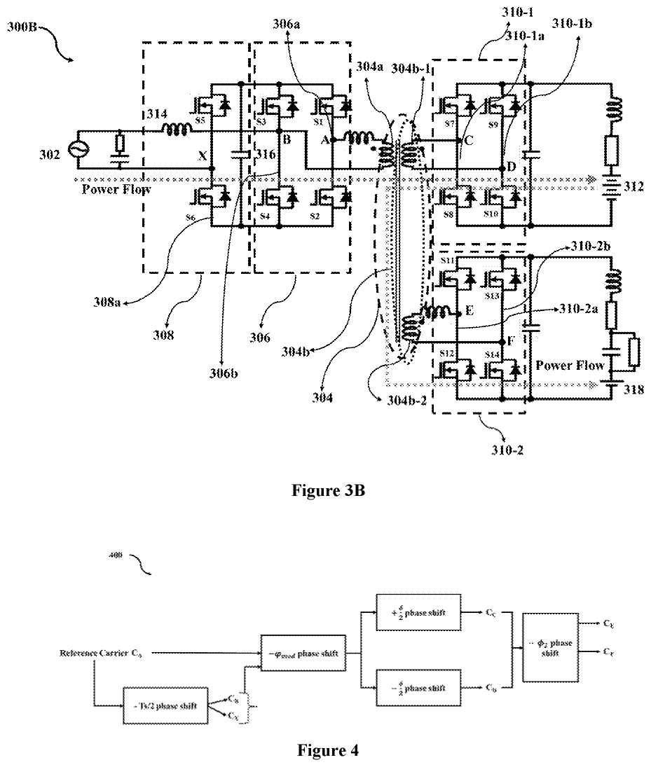

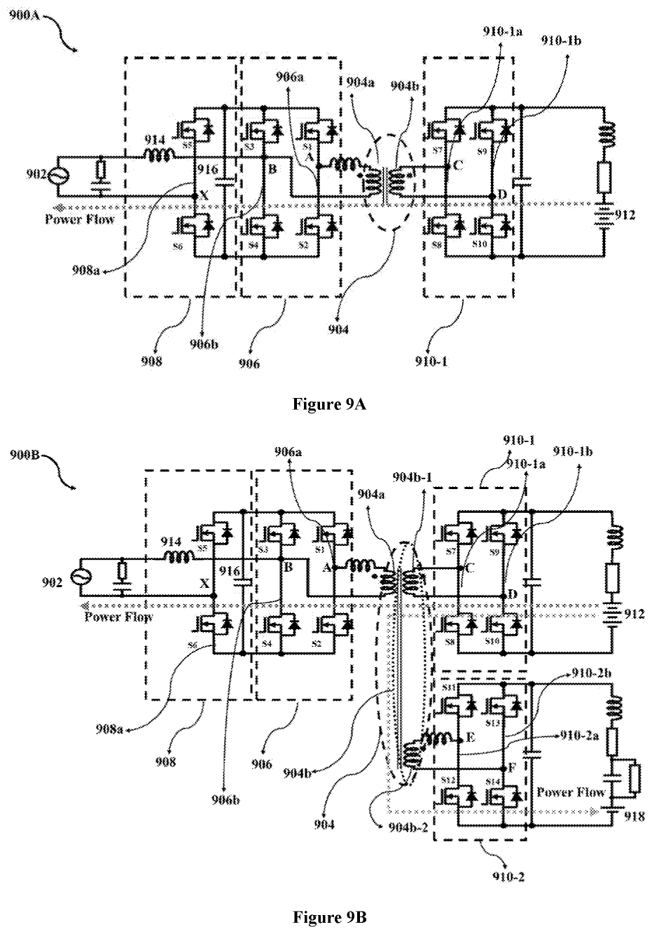

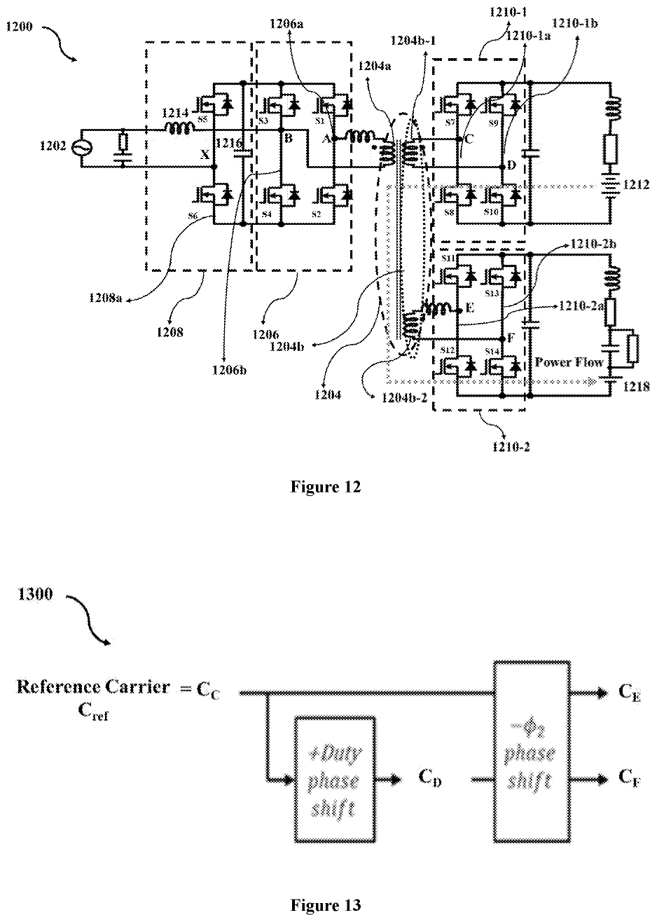

In an embodiment, during the G2V and the V2G mode of operation, the controller 104 is configured to control five control variables in the three-port configuration of the OBC and control three control variables in the two-port configuration of the OBC. The five control variables comprise: a voltage V_{AB} pulse duty associated with the primary winding 204a, a voltage V_{CD} pulse duty associated with the first winding 204b-1 of the secondary winding 204b, a voltage V_{EF} pulse duty associated with a second winding 204b-1 of the secondary winding 204b, a phase delay angle across the first winding 204b-1 of the secondary winding 204b with respect to the primary winding 204a and a phase delay angle of the second winding 204b-2 of the secondary winding 204b with respect to the first winding 204b-1 of the secondary winding 204b. On similar lines, the three control variables comprise a voltage V_{AB} pulse duty associated with the primary winding 204a, a voltage V_{CD} pulse duty associated with the secondary winding 204b and a phase delay angle across the secondary winding 204b with respect to the primary winding 204a. Further, by controlling the respective control variables for a plurality of combinations of loads and output voltages associated with the HVB load 212 and the LVB load 218 during an electrical cycle of a frequency associated with the source terminal 208, the controller 104 is able to control the input grid current harmonic distortion and the second harmonic battery ripple current within a pre-defined range-A detailed description of the control strategy implemented by the controller 104 during the different modes of operation of the OBC 106 is provided in the upcoming paragraphs in conjunction with FIGS. 3-15. In particular, the control/modulating strategy during the G2V mode is described in conjunction with FIGS. 3A, 3B, 4-7 and 8A-8E. Further, the control/modulation strategy during the V2G mode is described in conjunction with FIGS. 9A, 9B, 10 and 11A-11E. Lastly, the control/modulating strategy during the driving condition of the vehicle is described in conjunction with FIGS. 12-14 and 15A-15E.

### Modulation Strategy During G2V Mode—

FIGS. 3A and 3B depict power flow within circuits 300A and 300B of the single stage isolated two-port and three-port On-Board Charger (OBC), respectively during the Grid-to-Vehicle (G2V) operating mode, in accordance with an embodiment of the present disclosure. It may be appreciated by a skilled person that the circuits 300A and 300B comprise various components analogous to those depicted in FIGS. 2A and 2B respectively, and hence, description of the same is avoided for the sake of brevity.

During the G2V mode, power flows from a source terminal 302 to an HVB load 312 in the two-port configuration as depicted in FIG. 3A. However, in the three-port configuration, power flows from the source terminal 302 to the HVB load 312 and from the HVB load 312 to a LVB load 318 as depicted in FIG. 3B. In an embodiment, during the G2V mode, to control second harmonic battery ripple current in the two-port configuration or the three-port configuration, the controller 104 implements a control strategy for—
a) a first full bridge converter 306 and an active power decoupling circuit 308,
b) a second full bridge converter 310-1 connected to the HVB load 312.

In another embodiment, during the G2V mode, to control second harmonic battery ripple current in the three-port configuration, the controller 104 additionally implements a control strategy for—
a) a second full bridge converter 310-2 connected to the LVB load 318.

### Modulation Strategy for a First Switching Circuit 306a and a Second Switching Circuit 306b of the First Full Bridge Converter 306 and a Third Switching Circuit 308a of the Active Power Decoupling Circuit 308—

The controller 104 is configured to select a carrier associated with the first switching circuit 306a as a reference carrier. The same is depicted in FIG. 4 denoted by reference numeral C_{A}. The controller 104 is further configured to phase delay a carrier C_{B}, C_{X} associated with the second switching circuit 306b of the first full-bridge converter 306 and the third switching circuit 308a of the active power decoupling circuit 308 with respect to the reference carrier C_{A} by a first predefined angle. In an embodiment, the first predefined angle is equal to half switching period (Tₛ/2) as depicted in FIG. 4. The carriers C_{A}, C_{B}, C_{X} for the first switching circuit 306a, the second switching circuit 306b and the third switching circuit 308a are mathematically defined by equations 1-3—

$${C}_{A} = f ( t ) \qquad ( 1 )$$

$${C}_{B} = f ( t - {T}_{s} / 2 ) \qquad ( 2 )$$

$${C}_{X} = f ( t - {T}_{s} / 2 ) \qquad ( 3 )$$

In an embodiment, carrier frequencies associated with the carriers C_{A}, C_{B} and C_{X} have a fixed value equal to an operating frequency of the OBC 102.

The controller 104 is further configured to determine a modulating signal M_{AB}, M_{X} for the carriers C_{A}, C_{B} associated with the first and the second switching circuits 306a, 306b and for the carrier C_{X} associated with the third switching circuit 308a, based on a base modulating signal M_{ac}. In one embodiment, the base modulating signal M_{ac} is given by equation (4)—

M_{ac}=0.5×M sin ωt (4)

where, M is a modulation index and ωt denotes the angular frequency of the source terminal 302.

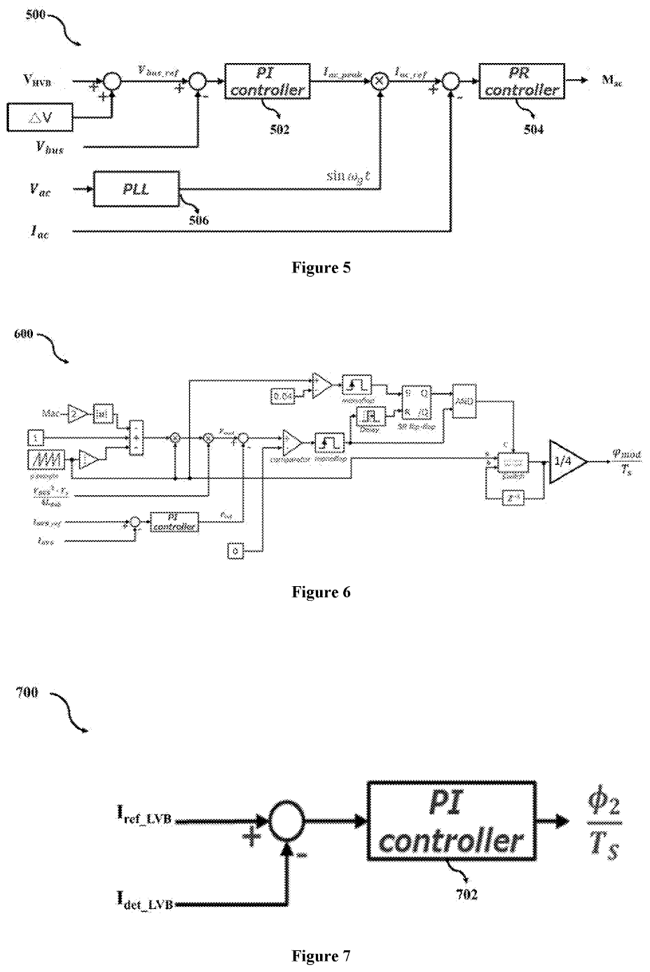

The generation of the base modulating signal M_{ac} is described herein with reference to FIG. 5. To generate the base modulating signal M_{ac}, a Proportional Integral (PI) controller 502 of the controller 104 is configured to generate a grid current I_{ac} associated with the source terminal 302. In particular, a peak value of the grid current I_{ac} is generated based on a difference between a reference bus voltage V_{bus_ref} and a detected bus voltage V_{bus}. In an embodiment, the reference bus voltage is a voltage across a capacitor 316 and the voltage across the capacitor 316 is determined by adding a voltage ΔV to the voltage V_{HVB} across the HVB load 312. The generated grid current I_{ac} is multiplied with a sine function generated from a Phase Locked Loop (PLL) 506 to generate a reference grid current I_{ac_ref}. A Proportional Resonant (PR) controller 504 of the controller 104 processes the difference between the reference grid current I_{ac_ref} and the detected grid current I_{ac} to generate the base modulating signal M_{ac}.

Now, to generate the modulating signals for the carriers C_{A}, C_{B} and Cₓ, the controller 104 is configured to perform sinusoidal pulse width modulation at the ac-side of the bridge i.e., the first full bridge converter 306 and the active power decoupling circuit 308, for direct ac-current control. To achieve this, the modulating signal M_{AB} for the first and the second switching circuits 306a and 306b and the modulating signal Mₓ for the third switching circuit 308a are configured to be 180° opposite to each other and is expressed by equations (5)-(6) as follows:

$${M}_{AB} = 0.5 + {M}_{a c} \qquad ( 5 )$$

$${M}_{X} = 0.5 - {M}_{a c} \qquad ( 6 )$$

In view of the above described modulation strategy for the first full bridge converter 306 and the active power decoupling circuit 308, since the carriers C_{B} and Cₓ for the second and the third switching circuits 306b, 308a are same, only a line-frequency component of a switch node voltage V_{BX} appears on the source terminal 302 and the switching frequency ripple appears across an input filter inductor 314. Further, a varying pulse width high frequency voltage V_{AB} appears across the primary winding 304a. Thus, the third switching circuit 308a along with the input filter inductor 314 and the capacitor 316 provides active power decoupling and suppresses the second harmonic power ripple.

### Modulation Strategy for the Second Full Bridge Converter 310-1 Connected to the HVB Load 312

The controller 104 is configured to phase delay a carrier C_{C} associated with a fourth switching circuit 310-1a with respect to the reference carrier C_{A} by a second predefined angle. In one embodiment, the second predefined angle is equal to −φ_{mod}+δ/2 as depicted in FIG. 4. The controller 104 is further configured to phase delay a carrier C_{D} associated with a fifth switching circuit 310-1b with respect to the carrier C_{B} by a third predefined angle. In one embodiment, the third predefined angle is equal to −φ_{mod}−δ/2 as depicted in FIG. 4.

In an embodiment, the second and the third predefined angles comprise a first and a second variable phase shift component VPS₁, VPS₂. The first variable phase shift component VPS₁ is denoted by φ_{mod} and the second variable phase shift component VPS₂ is denoted by δ/2, where δ is defined by equation (7) as follows—

δ=M_{ac}(t)*Tₛ (7)

where, Tₛ denotes the switching period.

The first variable phase shift component VPS₁ denoted by φ_{mod} is required to transfer power from the primary winding 304a to the secondary winding 304b and varies at a frequency which is twice the frequency of the source terminal 302 (alternatively referred to as grid frequency). The variation of φ_{mod} at twice the frequency of the source terminal 302 is required to transfer DC power without any second harmonic ripple power from the primary side winding 304a to the secondary side winding 304b. The second variable phase component VPS₂ denoted by δ/2 ensures sinusoidal phase shift modulation.

In an embodiment, the first variable phase shift component is determined by the controller 104 based on a power transfer equation (8) given below—

$${P}_{D A B \vert {T}_{S}} = \frac{{V}_{BUS}^{2} {T}_{s}}{4 {L}_{D A B}} p ( 1 - \vert {m}_{a c} \vert - \frac{p}{4} ) \qquad ( 8 )$$

$$φ = {φ}_{m o d} = \frac{{T}_{s}}{4} p \qquad ( 9 )$$

where ‘p’ is a ramp function, m_{ac} is a sinusoidal function decided based on the line side current and is given as m_{ac}=2*M_{ac}, V_{BUS} is the bus voltage i.e. the detected voltage of the storage capacitor 316 in the active power decoupling circuit 308, L_{DAB} is the inductance of the inductor 314 connected across the dual active bridge in the primary side and Tₛ is the switching period.

The controller 104 may continuously calculate a modulated power P_{mod} for various values of the ramp function “p” from equation (8). Simultaneously, as depicted in FIG. 6, the controller 104 may estimate a reference power (P_{ref}) based on a difference between reference current I_{HVB_ref} through the HVB battery load 312 and a detected current I_{HVB} through the HVB battery load 312. The value of the ramp function “p” where both the modulated power P_{mod} and the reference power P_{ref} are equal is noted by the controller 104 and then the phase shift φ_{mod} is calculated by the controller 104 from equation (9).

In another embodiment, the value of the first variable phase shift component φ_{mod} may be determined offline by the controller 104 based on one or more look-up tables. In an exemplary aspect, each of the one or more look up tables comprise a plurality of angle values for an electrical cycle of a frequency associated with the source terminal 302 at a corresponding plurality of values associated with the modulation index ‘M’ of the first full-bridge converter 306.

In an embodiment, carrier time periods associated with the carriers C_{C} and C_{D} are variable.

The controller 104 is further configured to determine a modulating signal M_{C}, M_{D} for the carriers C_{C} and C_{D} associated with the fourth and the fifth switching circuits 310-1a and 310-1b. In one embodiment the modulating signal M_{C} for the carrier C_{C} associated with the fourth switching circuit 310-1a and the modulating signal M_{D} for the carrier C_{D} associated with the fifth switching circuit 310-1b has a same value which is equal to 0.5 i.e., 50% of a duty period of the second full-bridge converter 310-1.

The modulation strategy for the second full bridge converter 310-1 connected to the HVB load 312 is such that in each pulse width, the phase voltage V_{CD} across the first winding 304b-1 of the secondary winding 304b lags the phase voltage V_{AB} across the primary winding 304a by the angle φ_{mod}. Hence, power is transferred from the primary winding 304a connected across the source terminal 302 to the first winding 304b-1 of the secondary winding 304b connected across the HVB load 312 and charging of the HVB load 312 is carried out.

### Modulation Strategy for the Second Full Bridge Converter 310-2 Connected to the LVB Load 318

The controller 104 is configured to phase delay a carrier C_{E} associated with a sixth switching circuit 310-2a with respect to the carrier C_{C} associated with the fourth switching circuit 310-1a by a fourth predefined angle. The controller 104 is further configured to phase delay a carrier C_{F} associated with a seventh switching circuit 310-2a with respect to the carrier C_{D} associated with the fifth switching circuit 310-1b by the fourth predefined angle. In one embodiment, the fourth predefined angle is equal to −φ₂ as depicted in FIG. 4 and the value of φ₂ is decided by the controller 104 based on a value of the charging power of the LVB load 318. In particular, to determine the value of φ₂, a difference between a reference current (I_{ref_LVB}) and a detected current (I_{det_LVB}) through the LVB load 318 is processed through a PI controller 702 of the controller 104 as depicted in FIG. 7.

In an embodiment, carrier time periods associated with the carriers C_{E} and C_{F} are variable.

The controller 104 is further configured to determine a modulating signal M_{E}, M_{F} for the carriers C_{E} and C_{F} associated with the sixth and the seventh switching circuits 310-2a and 310-2b. In one embodiment the modulating signal M_{E} for the carrier C_{E} associated with the sixth switching circuit 310-2a and the modulating signal M_{F} for the carrier C_{F} associated with the seventh switching circuit 310-2b has a same value which is equal to 0.5 i.e., 50% of a duty period of the second full-bridge converter 310-2.

The modulation strategy for the second full bridge converter 310-2 connected to the LVB load 318 is such that in each pulse width, the phase voltage V_{EF} across the second winding 304b-2 of the secondary winding 304b lags the phase voltage V_{CD} across the first winding 304b-1 of the secondary winding 304b by the angle Ø2. Hence, power is transferred from the first winding 304-b1 of the secondary winding 304b to the second winding 304-b2 of the secondary winding 304-b and hence charging of the LVB load 318 is accomplished.

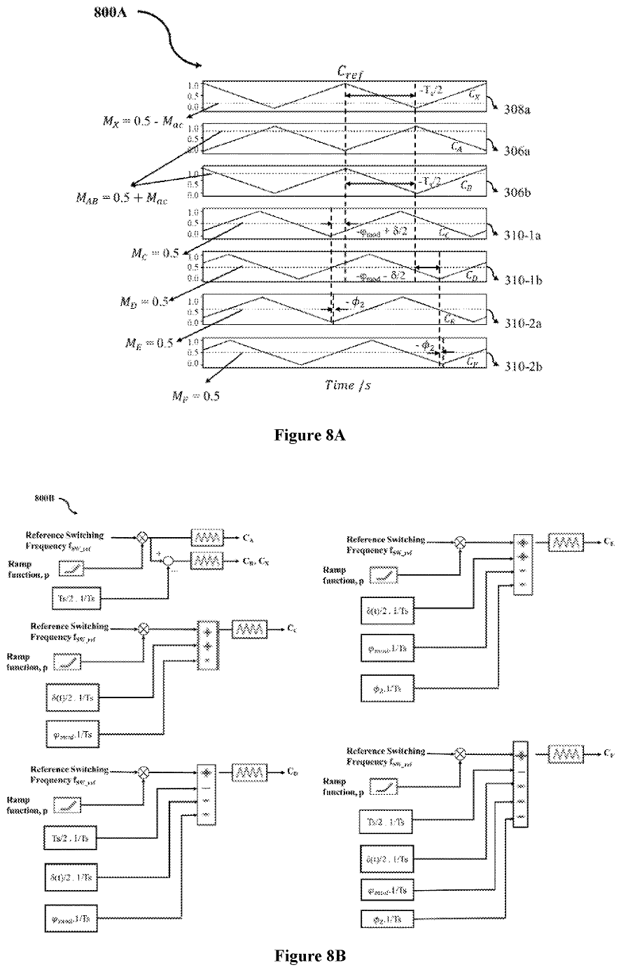

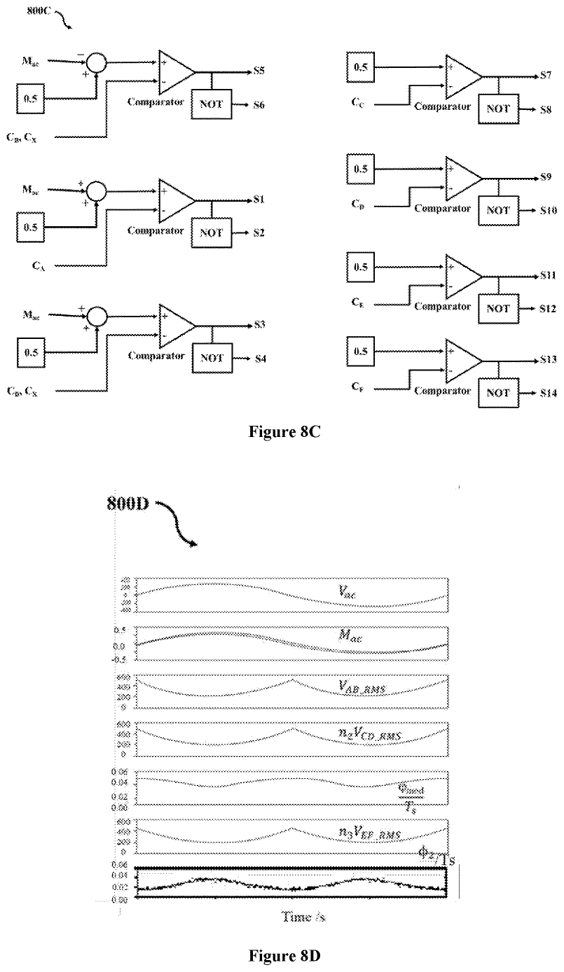

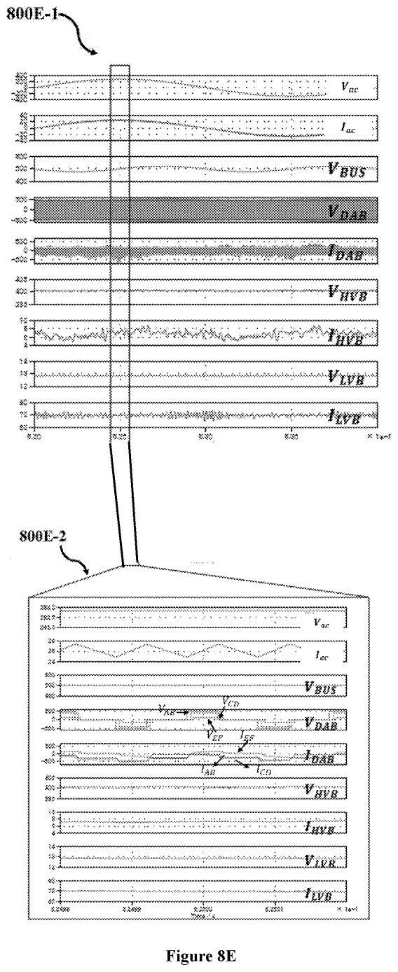

FIGS. 8A-8E depict waveforms 800A-800E respectively corresponding to carriers, modulation signals and voltages across the ac-side and the dc-side of the dual-active bridge converter. In particular, FIG. 8A depict waveforms corresponding to phase shift of the carriers corresponding to the first to seventh switching circuits denoted by reference numerals 306a, 306b, 308a, 310-1a, 310-1b, 310-2a and 310-2b along with their modulation signals. FIG. 8B depict generation of the carriers for the first to seventh switching circuits denoted by reference numerals 306a, 306b, 308a, 310-1a, 310-1b, 310-2a and 310-2b based on the ramp function “p”. FIG. 8C depict circuit diagrams for generation of the modulating signals corresponding to each switch associated with the first to the seventh switching circuits denoted by reference numerals 306a, 306b, 308a, 310-1a, 310-1b, 310-2a and 310-2b. FIG. 8D depicts waveforms illustrating a time-variation of: a) voltage V_{ac} associated with the source terminal 302, b) base modulating signal M_{ac}, c) voltage V_{AB} across the primary winding 304a, d) voltage V_{CD} across the first winding 304b-1 of the secondary winding 304b, e) the first variable phase shift component φ_{mod}, f) voltage V_{EF} across the second winding 304b-2 of the secondary winding 304b, and g) φ₂ in one electrical cycle. The waveforms 800E-1 depicted in FIG. 8E particularly depicts the grid current I_{ac}, the high voltage battery current (I_{HVB}) and the low voltage battery current (I_{LVB}) over one electrical cycle. It also depicts voltage V_{AB} across the primary winding 304a, the voltages V_{CD} and V_{EF} across the first 304b-1 and the second winding 304b-2 of the secondary winding 304b. It further depicts the current IAB across the primary winding 304a, the currents I_{CD} and I_{EF} across the first 304b-1 and the second windings 304b-2 of the secondary winding 304b. Further, the waveforms 800E-2 depicted in FIG. 8E is a zoomed version of the waveforms 800E-1 which shows that that the voltage V_{CD} across the first winding 304b-1 of the secondary winding 304b lags the voltage V_{AB} across the primary winding 304a as also described in the control strategy. The zoomed version also shows that the voltage V_{EF} across the second winding 304b-2 of the secondary winding 304b lags the voltage V_{CD} across the first winding 304b-1 of the secondary winding 304b as described in the control strategy.

### Modulation Strategy During V2G Mode—

FIGS. 9A and 9B depict power flow within circuits 900A and 900B of the single stage isolated two-port and three-port On-Board Charger (OBC), respectively during the Vehicle-to-Grid (V2G) operating mode, in accordance with an embodiment of the present disclosure. It may be appreciated by a skilled person that the circuits 900A and 900B comprise various components analogous to those depicted in FIGS. 2A and 2B, respectively and hence, description of the same is avoided for the sake of brevity.

During the V2G mode, power flows from an HVB load 912 to a source terminal 902 in a two-port configuration as depicted in FIG. 9A. However, in a three-port configuration, power flows from the HVB load 912 to the source terminal 902 and from the HVB load 912 to a LVB load 918 as depicted in FIG. 9B. In an embodiment, during the V2G mode, to control second harmonic battery ripple current of the High-Voltage Battery (HVB) load 912 in the two-port or the three-port configuration, the controller 104 implements a control strategy for—
a) a first full bridge converter 906 and an active power decoupling circuit 908,
b) a second full bridge converter 910-1 connected to the HVB load 912.

In another embodiment, during the V2G mode, to control the charging current of the Low-Voltage Battery (LVB) load 918, the controller 104 additionally implements a control strategy for—
a) a second full bridge converter 910-2 connected to the LVB load 918.

### Modulation Strategy for the Second Full Bridge Converter 910-1 Connected to the HVB Load 912

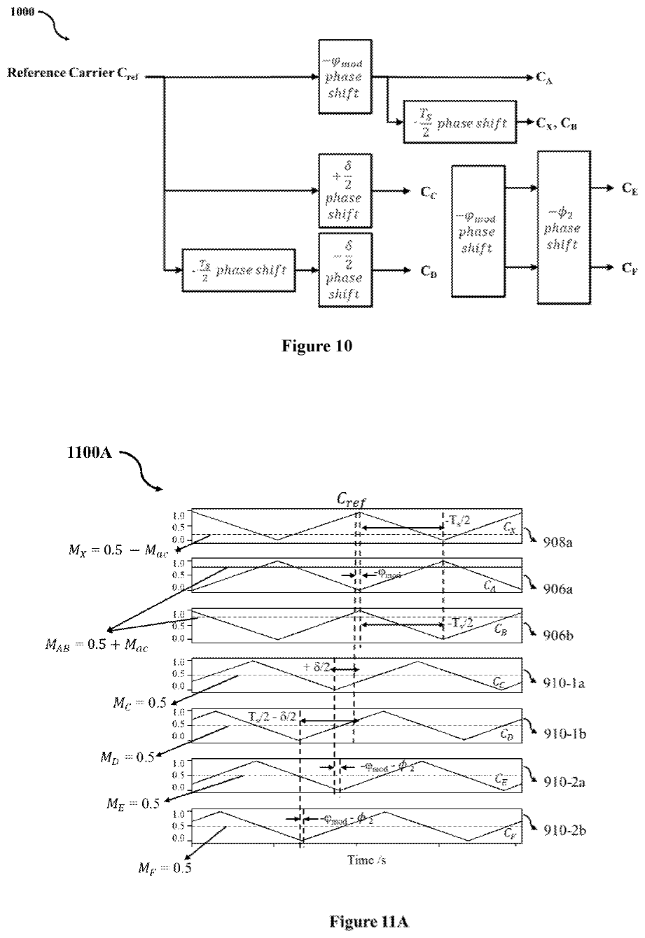

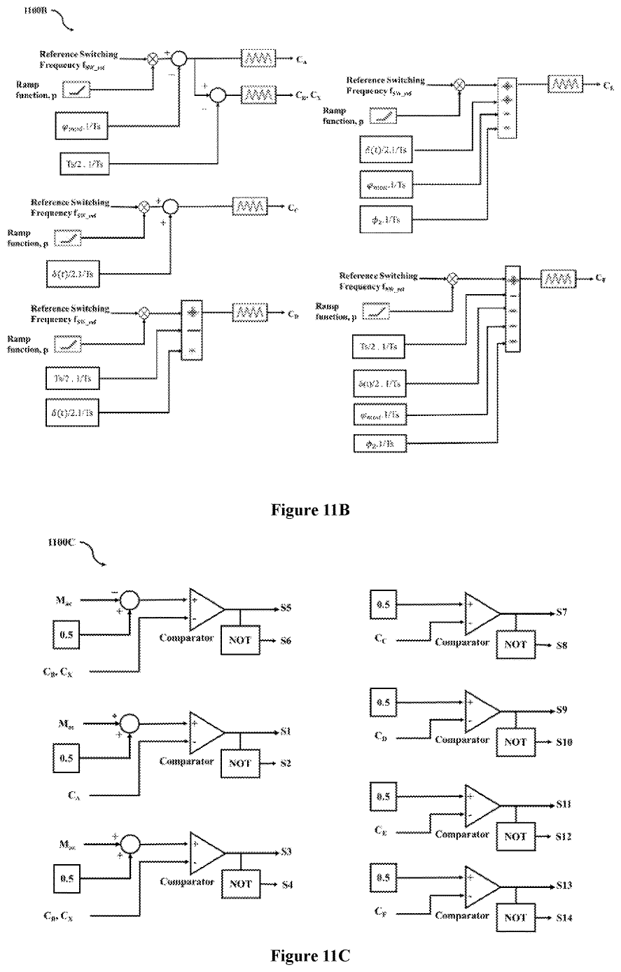

The controller 104 is configured to select a reference carrier C_{ref}. In an embodiment, the selected reference carrier C_{ref} has a time period equal to a half switching period Tₛ/2. Thereafter, the controller 104 phase advances a carrier C_{C} associated with a fourth switching circuit 910-1a of the second full-bridge converter 910-1 by a fifth predefined angle. In an embodiment, the fifth predefined angle is equal to +δ/2 as depicted in FIG. 10, where δ is defined by equation (7) as described in the preceding paragraphs. It may be appreciated by a skilled person that the phase advancement of the carrier C_{C} by an angle equivalent to +δ/2 is required to perform sinusoidal phase shift modulation at the dc-side of the dual-active bridge converter, i.e., at the second full-bridge converter 910-1 connected to the HVB load 912.

The controller 104 is further configured to phase advance a carrier C_{D} associated with a fifth switching circuit 910-1b of the second full-bridge converter 910-1 with respect to the selected reference carrier C_{ref} by a sixth predefined angle. In an embodiment, the sixth predefined angle is equal to Tₛ/2−δ/2 as depicted in FIG. 10.

In an embodiment, carrier time periods associated with the carriers C_{C} and C_{D} are variable.

The controller 104 is further configured to determine a modulating signal M_{C}, M_{D} for the carriers C_{C} and C_{D} associated with the fourth and the fifth switching circuits 910-1a and 910-1b. In one embodiment, the modulating signal M_{C} for the carrier C_{C} associated with the fourth switching circuit 910-1a and the modulating signal M_{D} for the carrier C_{D} associated with the fifth switching circuit 910-1b has a same value which is equal to 0.5 i.e., 50% of a duty period of the second full-bridge converter 910-1.

### Modulation Strategy for a First Switching Circuit 906a and a Second Switching Circuit 906b of the First Full Bridge Converter 906 and a Third Switching Circuit 908a of the Active Power Decoupling Circuit 908—

The controller 104 is configured to phase delay a carrier C_{A} associated with a first switching circuit 906a with respect to the selected reference carrier C_{ref} by a seventh predefined angle. In an embodiment, the seventh predefined angle is determined based on a discharge power of the HVB load 912 and is equal to −φ_{mod}. Further, the controller 104 is configured to phase delay a carrier C_{B} associated with the second switching circuit 906b and a carrier Cₓ associated with the third switching circuit 908a with respect to the selected reference carrier C_{ref} by an eighth predefined angle. In an embodiment, the eighth predefined angle is based on the half-switching period −Tₛ/2 and the seventh predefined angle −φ_{mod} and is equal to −Tₛ/2−φ_{mod}.

In an embodiment, the seventh predefined angle φ_{mod} is variable in nature and varies at a frequency which is twice the frequency of the source terminal 902 (alternatively referred to as grid frequency). Further, the variation of φ_{mod} at twice the frequency of the source terminal 902 is required to transfer DC power without any second harmonic ripple power from the winding 904b to the winding 904a (in the case of two-port configuration) or from the winding 904b-1 to the winding 904a (in the case of three-port configuration).

In an embodiment, the seventh predefined angle is determined by the controller 104 based on the equations (8) and (9) and the associated functionality described in preceding paragraphs in conjunction with FIG. 6. In another embodiment, the seventh predefined angle may be determined offline by the controller 104 by using the one or more look-up tables as described in the preceding paragraphs.

In an embodiment, carrier frequencies associated with the carriers C_{A}, C_{B} and C_{X} are variable.

The controller 104 is further configured to determine a modulating signal M_{AB}, M_{X} for the carriers C_{A}, C_{B} associated with the first and the second switching circuits 906a, 906b and for the carrier C_{X} associated with the third switching circuit 908a, based on a base modulating signal M_{ac}. In one embodiment, the base modulating signal M_{ac} is given by equation (4) as described in the preceding paragraphs. The generation of the base modulating signal M_{ac} is described in the preceding paragraphs in conjunction with FIG. 5.

Now, to generate the modulating signals M_{AB}, M_{X} for the carriers C_{A}, C_{B} and Cₓ, the controller 104 is configured to perform sinusoidal pulse width modulation at the ac-side of the bridge i.e., the first full bridge converter 906 and the active power decoupling circuit 908, for direct ac-current control. To achieve this, the modulating signal M_{AB} for the first and the second switching circuits 906a and 906b and the modulating signal Mₓ for the third switching circuit 908a are configured to be 180° opposite to each other and is expressed by equations (10)-(11) as follows:

$${M}_{AB} = 0.5 + {M}_{a c} \qquad ( 10 )$$

$${M}_{X} = 0.5 - {M}_{a c} \qquad ( 11 )$$

The modulation strategy for the first switching circuit 906a and the second switching circuit 906b of the first full bridge converter 906 and the third switching circuit 908a of the active power decoupling circuit 908 is such that in each pulse width, a voltage V_{AB} across the primary winding 904a lags a voltage V_{CD} across the first winding 904b-1 of the secondary winding 904b by an angle equal to the seventh predefined angle. This allows power to be transferred from the winding 904b to the winding 904a (in case of two-port configuration) or from the winding 904b-1 to the winding 904a (in case of three-port configuration), thereby allowing power discharge from the HVB load 912 to the source terminal 902.

### Modulation Strategy for the Second Full Bridge Converter 910-2 Connected to the LVB Load 918—

The controller 104 is configured to phase delay a carrier C_{E} associated with a sixth switching circuit 910-2a of the second full-bridge converter 910-2 with respect to the carrier associated with the fourth switching circuit 910-1a by a nineth predefined angle. The controller 104 is further configured to phase delay a carrier C_{F} associated with the seventh switching circuit 910-2b of the second full-bridge converter 910-2 with respect to the carrier associated with the fifth switching circuit 910-1b by the nineth predefined angle. In an exemplary embodiment, the nineth predefined angle is equal to (−φ_{mod}−φ₂) as depicted in FIG. 10.

In an exemplary aspect the generation of the component “φ₂” is performed by the controller 104 as depicted in FIG. 7 and described in preceding paragraphs. Further, in one embodiment, the component φ_{mod} of the nineth predefined angle is generated by the controller 104 online as described in the preceding paragraphs in conjunction with FIG. 6. However, in another embodiment, the component φ_{mod} may be generated offline by the controller 104 by utilizing the one or more look-up tables as described in the preceding paragraphs.

In an embodiment, carrier time periods associated with the carriers C_{E} and C_{F} are variable.

The controller 104 is further configured to determine a modulating signal M_{E}, M_{F} for the carriers C_{E} and C_{F} associated with the sixth and the seventh switching circuits 910-2a and 910-2b. In one embodiment, the modulating signal M_{E} for the carrier C_{E} associated with the sixth switching circuit 910-2a and the modulating signal M_{F} for the carrier C_{F} associated with the seventh switching circuit 910-2b has a same value which is equal to 0.5 i.e., 50% of a duty period of the second full-bridge converter 910-2.

The modulation strategy for the second full bridge converter 910-2 is such that in each pulse width, a voltage V_{EF} across a second winding 904b-2 of the secondary winding 904b lags a voltage across the first winding 904b-1 of the secondary winding 904b by an angle equal to the nineth predefined angle −φ_{mod}−φ₂. This allows power to be transferred from the first winding 904b-1 to the second winding 904b-2, thereby enabling charging of the LVB load 918.

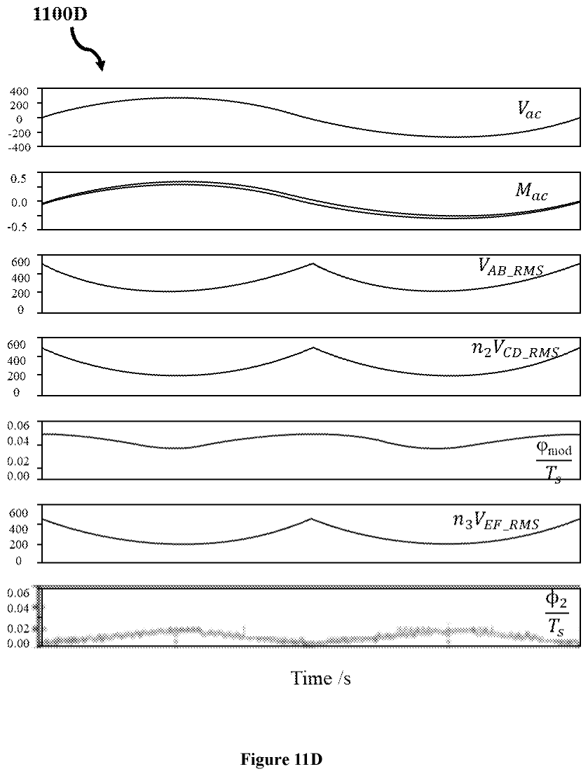

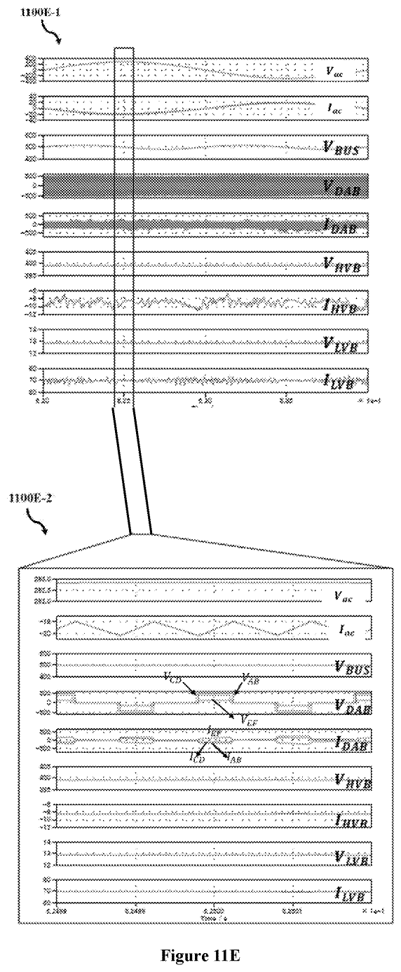

FIGS. 11A-11E depict waveforms 1100A-1100E respectively corresponding to carriers, modulation signals and voltages across the ac-side and the dc-side of the dual-active bridge converter. In particular, FIG. 11A depict waveforms corresponding to phase shift of the carriers corresponding to the first to seventh switching circuits denoted by reference numerals 906a, 906b, 908a, 910-1a, 910-1b, 910-2a and 910-2b along with their modulation signals. FIG. 11B depict generation of the carriers for the first to seventh switching circuits denoted by reference numerals 906a, 906b, 908a, 910-1a, 910-1b, 910-2a and 910-2b based on the ramp function “p”. FIG. 11C depict circuit diagrams for generation of the modulating signals corresponding to each switch associated with the first to the seventh switching circuits denoted by reference numerals 906a, 906b, 908a, 910-1a, 910-1b, 910-2a and 910-2b. FIG. 11D depicts waveforms illustrating a time-variation of: a) voltage V_{ac} associated with the source terminal 902, b) base modulating signal M_{ac}, c) voltage V_{AB} across the primary winding 904a, d) voltage V_{CD} across the first winding 904b-1 of the secondary winding 904b, e) φ_{mod}, f) voltage V_{EF} across the second winding 904b-2 of the secondary winding 904b, and g) φ₂ in one electrical cycle. The waveforms 1100E-1 depicted in FIG. 11E particularly depicts the grid current I_{ac}, the high voltage battery current (I_{HVB}) and the low voltage battery current (I_{LVB}) over one electrical cycle. It also depicts voltage V_{AB} across the primary winding 904a, the voltages V_{CD} and V_{EF} across the first 904b-1 and the second windings 904b-2 of the secondary winding 904b. It further depicts the current IAB across the primary winding 904a, the currents I_{CD} and I_{EF} across the first 904b-1 and the second windings 904b-2 of the secondary winding 904b. Further, the waveforms 1100E-2 illustrated in FIG. 11E is a zoomed version of the waveforms 1100E-1 which shows that that the voltage V_{AB} across the primary winding 904a lags the voltage V_{CD} across the first winding 904b-1 of the secondary winding 904b as also described in the control strategy. The zoomed version also shows that the voltage V_{EF} across the second winding 904b-2 of the secondary winding 904b lags the voltage across the voltage V_{CD} across the first windings 904b-1 of the secondary winding 904b as described in the control strategy.

### Modulation Strategy During Driving Condition of a Vehicle—

FIG. 12 depicts power flow within a circuit 1200 of the single stage isolated three-port On-Board Charger (OBC), during the driving condition of a vehicle, in accordance with an embodiment of the present disclosure. It may be appreciated by a skilled person that the circuit 1200 comprise various components analogous to those depicted in FIG. 2B, and hence, description of the same is avoided for the sake of brevity.

During the driving condition of a vehicle, i.e., during the vehicle (V) mode, power flows from a second full-bridge converter 1210-1 connected to a HVB load 1212, to a second full bridge converter 1210-2 connected to a LVB load 1218 as depicted in FIG. 12. There is no power flow in the ac-side of a dual-active bridge converter comprising a first full-bridge converter 1206 and an active power decoupling circuit 1208. Therefore, during driving condition of the vehicle, to charge the Low-Voltage Battery (LVB) load 1218 from the High-Voltage Battery (HVB) load 1212 in the three-port configuration, the controller 104 implements a control strategy for—
a) the second full-bridge converter 1210-1 connected to the HVB load 1212, and
b) the second full-bridge converter 1210-2 connected to the LVB load 1218.

### Modulation Strategy for the Second Full-Bridge Converter 1210-1 Connected to the HVB Load 1212—

The controller 104 is configured to select a carrier C_{C} associated with a fourth switching circuit 1210-1a of the second full-bridge converter 1210-1, as reference carrier C_{ref} as depicted in FIG. 13. Thereafter, the controller 104 phase advances a carrier C_{D} associated with a fifth switching circuit 1210-1b of the second full-bridge converter 1210-1, by a time period which is equal to a duty period of the second full-bridge converters 1210-1 and 1210-2 as also depicted in FIG. 13. In an embodiment, the duty period is configured by the controller 104 to have a value less than half of a switching period.

The controller 104 is further configured to determine a modulating signal M_{C}, M_{D} for the carriers C_{C} and C_{D} associated with the fourth and the fifth switching circuits 1210-1a and 1210-1b. In one embodiment, the modulating signal M_{C} for the carrier C_{C} associated with the fourth switching circuit 1210-1a and the modulating signal M_{D} for the carrier C_{D} associated with the fifth switching circuit 1210-1b has a same value which is equal to 0.5 i.e., 50% of a duty period of the second full-bridge converter 1210-1.

### Modulation Strategy for the Second Full-Bridge Converter 1210-2 Connected to the LVB Load 1218—

The controller 104 is configured to phase delay a carrier C_{E} associated with a sixth switching circuit 1210-2a of the second full-bridge converter 1210-2 connected to the LVB load 1218 with respect to the selected reference carrier C_{ref} (or C_{C}) by a tenth predefined angle. The controller 104 is further configured to phase delay a carrier C_{F} associated with a seventh switching circuit 1210-2b of the second full-bridge converter 1210-2 connected to the LVB load 1218 with respect to the carrier C_{D} associated with the fifth switching circuit 1210-1b by the tenth predefined angle. In an exemplary aspect, the tenth predefined angle is equal to φ₂ as depicted in FIG. 13. Further, the controller 104 is configured to determine the tenth predefined angle φ₂ as described in the preceding paragraphs with reference to FIG. 7.

The controller 104 is further configured to determine a modulating signal M_{E}, M_{F} for the carriers C_{E} and C_{F} associated with the sixth and the seventh switching circuits 1210-2a and 1210-2b. In one embodiment, the modulating signal M_{E} for the carrier C_{E} associated with the sixth switching circuit 1210-2a and the modulating signal M_{F} for the carrier C_{F} associated with the seventh switching circuit 1210-2b has a same value which is equal to 0.5 i.e., 50% of a duty period of the second full-bridge converter 1210-2.

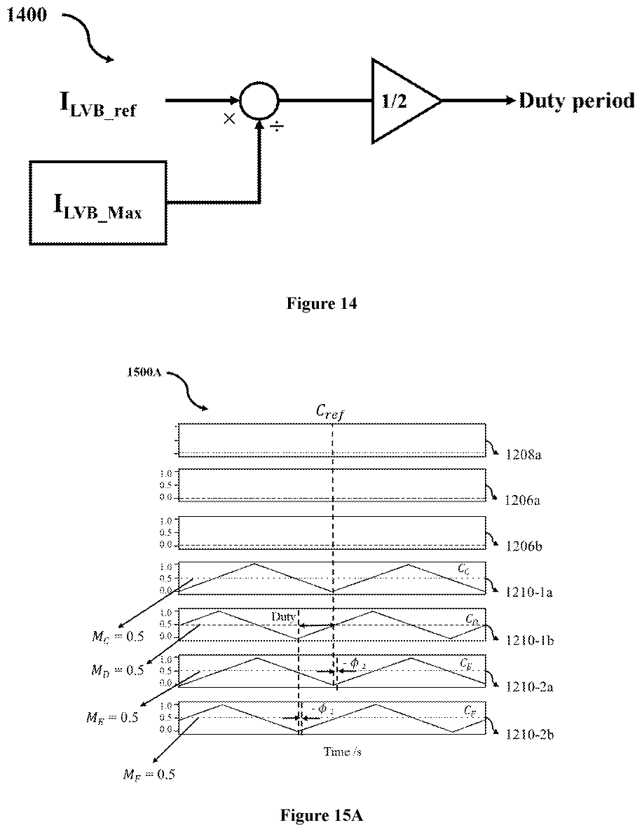

The modulation strategy for the second full bridge converters 1210-1 and 1210-2 is such that a carrier frequency of the carriers C_{C}, C_{D}, C_{E} and C_{F} associated with the fourth, fifth, sixth and seventh switching circuits 1210-1a, 1210-1b, 1210-2a, 1210-2b respectively, is fixed by the controller 104 and is made equal to an operating switching frequency of the OBC 102. Further, the controller 104 is configured to vary the duty period and the tenth predefined angle based on the voltages associated with HVB load 1212 and the LVB load 1218, and a charging load of the LVB load 1218. In one exemplary, to determine the value of duty period, as depicted in FIG. 14, the controller 104 is configured to divide a reference current through the LVB load 1218 I_{LVB_ref} by a maximum current flowing through the LVB load 1218 I_{LVB_Max}. The controller 104 then multiples the result of the division by the half duty period (Tₛ/2) i.e. 0.5 to generate the Duty period during the driving condition of the vehicle.

Furthermore, the modulation strategy for the second full bridge converters 1210-1 and 1210-2 is such that in each pulse width a voltage V_{EF} across a second winding 1204b-2 of the secondary winding 1204b lags a voltage V_{CD} across the first winding 1204b-1 of the secondary winding 1204b by an angle equal to the tenth predefined angle. This allows power to be transferred from the first winding 1204b-1 to the second winding 1204b-2, thereby enabling charging of the LVB load 1218 from the HVB load 1212. Also, the voltages V_{CD} and V_{EF} are proportional to the duty period.

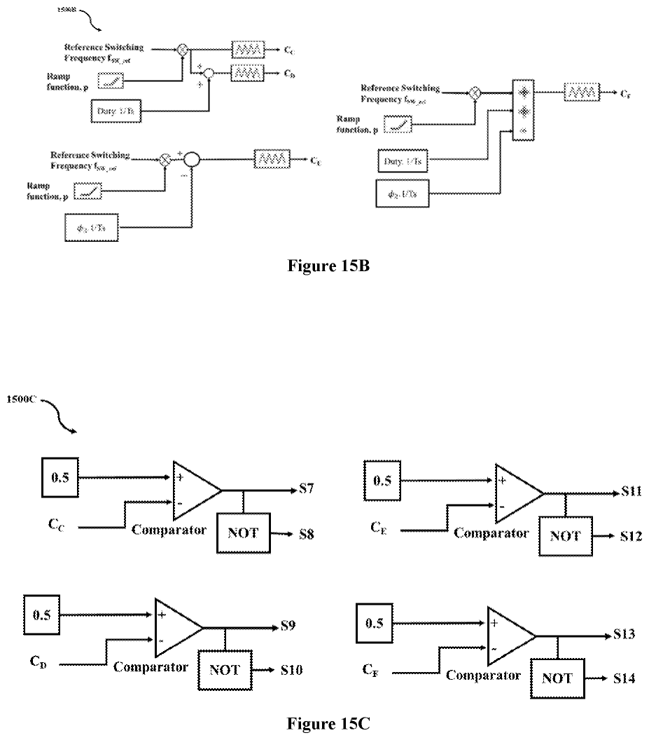

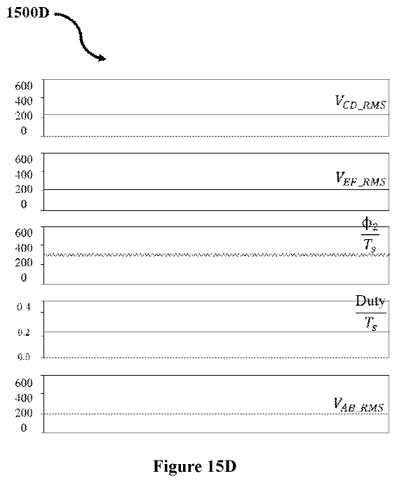

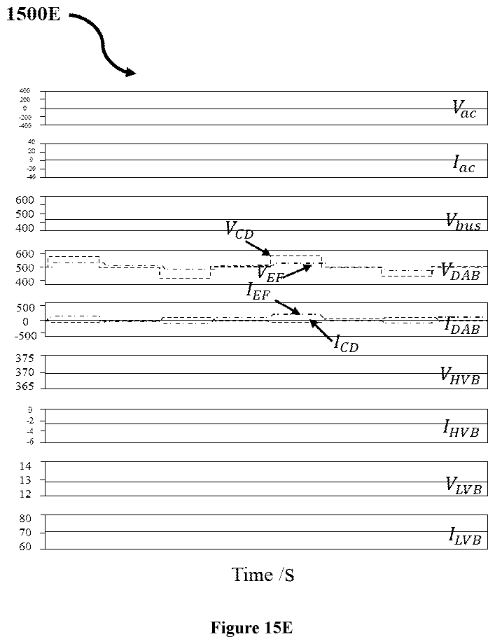

FIGS. 15A-15E depict waveforms 1500A-1500E respectively corresponding to carriers, modulation signals and voltages across the ac-side and the dc-side of the dual-active bridge converter. In particular, FIG. 15A depict waveforms corresponding to phase shift of the carriers corresponding to the fourth to seventh switching circuits denoted by reference numerals 1210-1a, 1210-1b, 1210-2a and 1210-2b along with their modulation signals. FIG. 15B depict generation of the carriers for the fourth to seventh switching circuits denoted by reference numerals 1210-1a, 1210-1b, 1210-2a and 1210-2b based on the ramp function “p”. FIG. 15C depict circuit diagrams for generation of the modulating signals corresponding to each switch associated with the fourth to the seventh switching circuits denoted by reference numerals 1210-1a, 1210-1b, 1210-2a and 1210-2b. FIG. 15D depicts waveforms illustrating a time-variation of: a) voltage V_{CD} across the first winding 1204b-1 of the secondary winding 1204b, b) voltage V_{EF} across the second winding 904b-2 of the secondary winding 904b, c) φ₂, d) the duty period, and e) the voltage V_{AB} across the primary winding 1204a. Lastly, FIG. 15E particularly depicts that the voltage V_{EF} across the second winding 1204b-2 of the secondary winding 1204b lags the voltage V_{CD} across the first winding 1204b-1 of the secondary winding 1204b as also described in the control strategy. It also depicts the high voltage battery current I_{HVB} and the low voltage battery current I_{LVB}.

The above-described control strategy for the single-stage isolated bidirectional multi-port OBC overcomes one of the major limitations of a single stage OBC, i.e., the presence of second harmonic battery ripple current which is detrimental to the life of a battery being charged by the OBC. In addition to this, the proposed control strategy restricts distortion in the input grid current. Furthermore, the present disclosure provides a single stage OBC that comprises fewer power electronics components and thus, is less bulky, is cost-effective and has high power-conversion efficiency.

A description of an embodiment with several components in communication with each other does not imply that all such components are required. On the contrary a variety of optional components are described to illustrate the wide variety of possible embodiments of the disclosure.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices. The functionality and/or the features of a device may be alternatively embodied by one or more other devices which are not explicitly described as having such functionality/features. Thus, other embodiments of the disclosure need not include the device itself.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the disclosure of the embodiments of the disclosure is intended to be illustrative, but not limiting, of the scope of the disclosure, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

We claim:

1. A single stage isolated bidirectional multi-port On-Board Charger (OBC), comprising:
a dual active bridge converter comprising:
a first full-bridge converter connected to a primary winding of a transformer, wherein the first full-bridge converter comprises a first switching circuit and a second switching circuit;
an active power decoupling circuit in electrical communication with a source terminal and the first full-bridge converter, wherein the active power decoupling circuit comprises a third switching circuit and one or more passive devices; and
one or more second full-bridge converters connected to one or more secondary windings of the transformer, wherein each of the one or more second full-bridge converters are connected to a load, and wherein each of the one or more second full-bridge converters comprises one or more second switching circuits; and
a controller in electrical communication with the dual-active bridge converter and configured to control an input grid current harmonic distortion and a second harmonic battery ripple current generated in the dual active bridge converter during one or more operating modes of the OBC.

2. The OBC as claimed in claim 1, wherein to control the input grid current harmonic distortion, the controller is configured to select a turn ratio of the transformer such that an amplitude of voltage across the primary winding is equal to an amplitude of voltage across the one or more secondary windings.

3. The OBC as claimed in claim 1, wherein to control the input grid current harmonic distortion and the second harmonic battery ripple current in the single stage isolated bidirectional multi-port OBC, the controller is configured to:
select:
a flat-top modulation strategy for the first full bridge converter and the one or more second full-bridge converters,
sinusoidal pulse width modulation for the first full bridge converter, and
sinusoidal phase shift modulation for the one or more second full-bridge converters;
select, a reference carrier based on one or more operating modes of the OBC;
determine, during each switching period, a phase shift of a carrier associated with at least one switching circuit of a plurality of switching circuits of the dual-active bridge converter, with respect to the selected reference carrier, such that a voltage across the one or more secondary windings has an identical pulse width and is phase modulated with respect to a voltage across the primary winding to transmit constant power through the dual-active bridge converter; and
determine a modulating signal based on the determined phase shift of the carrier.

4. The OBC as claimed in claim 1, wherein the OBC is configured in one of: a two-port configuration and a three-port configuration.

5. The OBC as claimed in claim 4, wherein in the two-port configuration, a dual active bridge converter comprises a second full-bridge converter connected to a High-Voltage battery (HVB) load.

6. The OBC as claimed in claim 4, wherein in the three-port configuration, a dual-active bridge converter comprises two second full-bridge converters, wherein one of the second full-bridge converters is connected to a High-Voltage Battery (HVB) load, and another second full-bridge converter is connected to a Low-Voltage Battery (LVB) load.

7. The OBC as claimed in claim 1, wherein the one or more operating modes comprises a Grid-to-Vehicle (G2V) mode and a Vehicle-to-Grid (V2G) mode at a rest condition of a vehicle and a Vehicle (V) mode during a driving condition of the vehicle.

8. The OBC as claimed in claim 1, wherein for a first switching circuit and a second switching circuit of a first full-bridge converter and a third switching circuit of an active power decoupling circuit associated with the dual-active bridge converter, to control the second harmonic battery ripple current in one of: a two-port and a three-port configuration during a Grid-to-Vehicle (G2V) operating mode, the controller is configured to:
select a carrier associated with the first switching circuit as a reference carrier;
phase delay a carrier associated with the second switching circuit and the third switching circuit with respect to the reference carrier by a first predefined angle,
wherein the first predefined angle is equal to a half switching period, and determine a modulating signal for the carrier associated with the first and the second switching circuits and for the carrier associated with the third switching circuit, based on a base modulating signal, such that the modulating signal for the carrier associated with the first and the second switching circuits is 180° opposite to the modulating signal for the carrier associated with the third switching circuit.

9. The OBC as claimed in claim 8, wherein for a second full-bridge converter of the dual-active bridge converter connected to a High-Voltage Battery (HVB) load, to control the second harmonic battery ripple current in one of: the two-port and the three-port configuration during the Grid-to-Vehicle (G2V) operating mode, the controller is further configured to:
phase delay a carrier associated with a fourth switching circuit of the second full-bridge converter connected to the HVB load with respect to the reference carrier by a second predefined angle;
phase delay a carrier associated with a fifth switching circuit of the second full-bridge converter connected to the HVB load with respect to the carrier associated with the second switching circuit by a third predefined angle,
wherein the second predefined angle comprises a summation of a first and a second variable phase shift component and the third predefined angle comprises a a subtraction of the first and the second variable phase shift components that contributes for a constant power transmission from the first full-bridge converter to the second full-bridge converter connected to the HVB load; and
determine a modulating signal for the carrier associated with the fourth and the fifth switching circuits, wherein the modulating signal for the carrier associated with fourth switching circuit and the modulating signal for the carrier associated with the fifth switching circuit has a same value equal to half of a duty period of the second full-bridge converter of the dual-active bridge converter connected to the HVB load,
wherein a voltage across a first winding of the secondary winding lags a voltage across the primary winding by an angle equal to the variable phase shift component, and wherein the variable phase shift component varies at a frequency which is twice a frequency associated with the source terminal.

10. The OBC as claimed in claim 8, wherein for a second full-bridge converter of the dual-active bridge converter connected to a Low-Voltage Battery (LVB) load, to control the second harmonic battery ripple current in the three-port configuration during the Grid-to-Vehicle (G2V) operating mode, the controller is further configured to:
phase delay a carrier associated with a sixth switching circuit of the second full-bridge converter connected to the LVB load with respect to the carrier associated with the fourth switching circuit by a fourth predefined angle,
phase delay a carrier associated with a seventh switching circuit of the second full-bridge converter connected to the LVB load with respect to the carrier associated with the fifth switching circuit by the fourth predefined angle; and
determine a modulating signal for the carrier associated with the sixth and the seventh switching circuits, wherein the modulating signal for the carrier associated with sixth switching circuit and the modulating signal for the carrier associated with the seventh switching circuit has a same value equal to half of a duty period of the second full-bridge converter of the dual-active bridge converter connected to the LVB load,
wherein a voltage across a second winding of the secondary winding lags a voltage across the first winding of the secondary winding by an angle equal to the fourth predefined angle, and
wherein the fourth predefined angle varies at a frequency which is twice a frequency associated with the source terminal.

11. The OBC as claimed in claim 1, wherein for a second full-bridge converter of the dual-active bridge converter connected to a High-Voltage Battery (HVB) load, to control the second harmonic battery ripple current in one of: a two-port and a three-port configuration during a Vehicle-to-Grid (V2G) operating mode, the controller is configured to:
select a reference carrier, wherein the selected reference carrier has a time period equal to a half switching period;
phase advance a carrier associated with a fourth switching circuit of the second full-bridge converter connected to the HVB load with respect to the selected reference carrier by a fifth predefined angle;
phase advance a carrier associated with a fifth switching circuit of the second full-bridge converter connected to the HVB load with respect to the selected reference carrier by a sixth predefined angle; and
determine a modulating signal for the carrier associated with the fourth and the fifth switching circuits, wherein the modulating signal for the carrier associated with fourth switching circuit and the modulating signal for the carrier associated with the fifth switching circuit has a same value equal to half of a duty period of the second full-bridge converter of the dual-active bridge converter connected to the HVB load.

12. The OBC as claimed in claim 11, wherein for a first switching circuit and a second switching circuit of a first full-bridge converter and a third switching circuit of an active power decoupling circuit associated with the dual-active bridge converter, to control the second harmonic battery ripple current in one of: the two-port and the three port configuration, during the V2G operating mode, the controller is further configured to:
phase delay a carrier associated with a first switching circuit with respect to the selected reference carrier by a seventh predefined angle, wherein the seventh predefined angle is determined based on a discharge power of the HVB load;
phase delay a carrier associated with a second switching circuit and a carrier associated with the third switching circuit with respect to the selected reference carrier by an eighth predefined angle, wherein the eighth predefined angle is based on the half-switching period and the seventh predefined angle; and
determine a modulating signal for the carrier associated with the first and the second switching circuits and for the carrier associated with the third switching circuit, based on a base modulating signal, such that the modulating signal for the carrier associated with the first and the second switching circuit is 180° opposite to the modulating signal for the carrier associated with the third switching circuit,
wherein a voltage across the primary winding lags a voltage across the first winding of the secondary winding by an angle equal to the seventh predefined angle, and wherein the seventh predefined angle varies at a frequency which is twice a frequency associated with the source terminal.

13. The OBC as claimed in claim 11, wherein for a second full-bridge converter of the dual-active bridge converter connected to a Low-Voltage Battery (LVB) load, to control the second harmonic battery ripple current in a three-port configuration, during the V2G operating mode, the controller is further configured to:
phase delay a carrier associated with a sixth switching circuit of the second full-bridge converter connected to the LVB load with respect to the carrier associated with the fourth switching circuit by a nineth predefined angle;
phase delay a carrier associated with the seventh switching circuit of the second full-bridge converter connected to the LVB load with respect to the carrier associated with the fifth switching circuit by the nineth predefined angle; and
determine a modulating signal for the carrier associated with the sixth and the seventh switching circuits, wherein the modulating signal for the carrier associated with sixth switching circuit and the modulating signal for the carrier associated with the seventh switching circuit has a same value equal to half of a duty period of the second full-bridge converter of the dual-active bridge converter connected to the LVB load,
wherein a voltage across a second winding of the secondary winding lags a voltage across the first winding of the secondary winding by an angle equal to the nineth predefined angle, and wherein the nineth predefined angle varies at a frequency which is twice a frequency associated with the source terminal.

14. The OBC as claimed in claim 1, wherein in a Grid-to-Vehicle (G2V) mode and in a Vehicle-to-Grid (V2G) operating mode, a carrier frequency of the first full-bridge converter is constant and is equal to an operating switching frequency of the OBC (102) and wherein carrier frequencies associated with the one or more second full-bridge converters (310, 910) are variable.

15. The OBC as claimed in claim 9, wherein the first variable phase shift component VPS₁ in G2V mode and the seventh predefined angle in the V2G mode are generated in one of: an online mode and an offline mode, wherein in the offline mode, the variable phase shift component and the seventh predefined angle is selected from one or more look up tables, and wherein each of the one or more look up tables comprise a plurality of angle values for an electrical cycle of a frequency associated with the source terminal at a corresponding plurality of values associated with a modulation index of the first full-bridge converter.

16. The OBC as claimed in claim 10, wherein in the three-port configuration, during the G2V and the V2G operating mode, the controller is configured to control a plurality of variables for a plurality of combinations of loads and output voltages associated with the HVB load and the LVB load in a manner that during an electrical cycle of a frequency associated with the source terminal, the input grid current harmonic distortion and the second harmonic battery ripple current generated in the HVB load are maintained within the pre-defined range.

17. The OBC as claimed in claim 16, wherein the plurality of control variables comprises voltage pulse duty associated with the primary winding, voltage pulse duty associated with a first winding of the one or more secondary windings, voltage pulse duty associated with a second winding of the one or more secondary windings, a phase delay angle across the first winding of the one or more secondary windings with respect to the primary winding and a phase delay angle of the second winding of the one or more secondary windings with respect to the first winding of the one or more secondary windings.

18. The OBC as claimed in claim 9, wherein in the two-port configuration, during the G2V and the V2G operating mode, the controller is configured to control a plurality of control variables for a plurality of combinations of loads and output voltage associated with the HVB load in a manner that during an electrical cycle of a frequency associated with the source terminal, the input grid current harmonic distortion and the second harmonic battery ripple current generated in the HVB load are maintained within the pre-defined range.

19. The OBC as claimed in claim 18, wherein the plurality of control variables comprises voltage pulse duty associated with the primary winding, voltage pulse duty associated with a secondary winding and a phase delay angle across the secondary winding with respect to the primary winding.

20. The OBC as claimed in claim 1, wherein for a second full-bridge converter of the dual-active bridge converter connected to a High-Voltage Battery (HVB) load in a three-port configuration, to charge the Low-Voltage Battery (LVB) from the High-Voltage Battery (HVB) during a driving condition of a vehicle, the controller is configured to:
select a carrier associated with a fourth switching circuit of the second full-bridge converter connected to the HVB load as a reference carrier, wherein a frequency of the carrier associated with the fourth switching circuit is equal to an operating frequency of the dual-active bridge converter;
phase advance a carrier associated with the fifth switching circuit of the second full-bridge converter connected to the HVB load with respect to the selected reference carrier by a time period equal to a duty cycle of the second full-bridge converter; and
determine a modulating signal for the carrier associated with the fourth and the fifth switching circuits, wherein the modulating signal for the carrier associated with fourth switching circuit and the modulating signal for the carrier associated with the fifth switching circuit has a same value equal to half of a duty period of the second full-bridge converter of the dual-active bridge converter connected to the HVB load.

21. The OBC as claimed in claim 20, wherein for a second full-bridge converter of the dual-active bridge converter connected to a Low-Voltage Battery (LVB) load in a three-port configuration, to charge the Low-Voltage Battery (LVB) from the High-Voltage Battery (HVB) during a driving condition of a vehicle, the controller is configured to:
phase delay a carrier associated with the sixth switching circuit of the second full-bridge converter connected to the LVB load with respect to the selected reference carrier by a tenth predefined angle;
phase delay a carrier associated with the seventh switching circuit of the second full-bridge converter connected to the LVB load with respect to the carrier associated with the fifth switching circuit by the tenth predefined angle; and
determine a modulating signal for the carrier associated with the sixth and the seventh switching circuits, wherein the modulating signal for the carrier associated with sixth switching circuit and the modulating signal for the carrier associated with the seventh switching circuit has a same value equal to half of a duty period of the second full-bridge converter of the dual-active bridge converter connected to the LVB load,
wherein a voltage across a second winding of the secondary winding lags a voltage across a first winding of the secondary winding by an angle equal to the tenth predefined angle.
